(19) United States
(12) Patent Application Publication
(10) Pub. No.: US 2025/0030977 A1
(43) Pub. Date: Jan. 23, 2025

(54) SOUND GENERATING APPARATUS AND ELECTRONIC DEVICE

(71) Applicant: HUAWEI TECHNOLOGIES CO., LTD., Shenzhen,Guangdong (CN)

(72) Inventors: Jiayi Chen, Beijing (CN); Yujiang Ding, Shanghai (CN); CHUNJIAN LI, Shanghai (CN); Chunjiao Pan, Beijing (CN)

(73) Assignee: HUAWEI TECHNOLOGIES CO., LTD., Shenzhen,Guangdong (CN)

(21) Appl. No.: 18/885,567

(22) Filed: Sep. 14, 2024

Related U.S. Application Data
(63) Continuation of application No. PCT/CN2023/087374, filed on Apr. 10, 2023.

(30) Foreign Application Priority Data
Apr. 14, 2022 (CN) 202210394548.3
Jul. 12, 2022 (CN) 202210812781.9

(51) Int. Cl. H04R 1/28; H04R 1/02; H04R 17/00; H04R 17/10

(52) U.S. Cl. CPC H04R 1/2849; H04R 1/023; H04R 1/025; H04R 17/005; H04R 17/10

(57) ABSTRACT

This application discloses an apparatus. The apparatus includes a housing, a transducer, a first valve, and a control circuit. The housing has an inner cavity and an opening, the transducer is installed in the inner cavity of the housing, and the first valve is fastened to the housing and covers the opening of the housing. The control circuit is electrically connected to the transducer and the first valve, the control circuit is configured to generate a first control signal and a second control signal, the first control signal is configured to drive the transducer to vibrate, and the second control signal is configured to control a switch on/off state of the first valve, so that the sound generating apparatus emits a plurality of air pulses to form audible sound, where a frequency of the audible sound is lower than a vibration frequency of the transducer.

### CROSS-REFERENCE TO RELATED APPLICATIONS

This application is a continuation of International Application No. PCT/CX/2023/087374, filed on Apr. 10, 2023, which claims priority to Chinese Patent Application No. 202210394548.3, filed on Apr. 14, 2022, and Chinese Patent Application No. 202210812781.9, filed on Jul. 12, 2022. All of the aforementioned patent applications are hereby incorporated by reference in their entireties.

### TECHNICAL FIELD

This application relates to the field of audio technologies, and in particular, to a sound generating apparatus and an electronic device.

### BACKGROUND

Miniature speakers are widely used in many consumer electronic products at present, providing audio entertainment for consumers and enhancing audio experience.

According to the physics of sound wave propagation, within a human audible frequency range (usually from 20 Hz to 20 kHz), sound pressure generated when a conventional speaker drives a vibrating membrane to vibrate may be expressed as

$$P = \frac{ρ Sd}{2 π r} A ,$$

where S_{d} is a surface area of the vibrating membrane, and A is acceleration of the vibrating membrane. To be specific, the sound pressure P is directly proportional to a product of the surface area S_{d} of the vibrating membrane and the acceleration A of the vibrating membrane. In addition, a relationship between displacement D of the vibrating membrane and the acceleration A of the vibrating membrane may be expressed as A=−w²D, where w is an angular frequency of a sound wave. An air movement caused when the conventional speaker drives the vibrating membrane to vibrate is expressed as V=D*S_{d}. Therefore, the sound pressure may be rewritten to

$$P = - \frac{ρ {w}^{2}}{2 π r} V .$$

To be specific, the sound pressure is directly proportional to the air movement V, and is directly proportional to the square of the angular frequency w.

For example, in a conventional electrodynamic speaker, a coil and a magnet are configured to generate a driving force for the vibrating membrane. Sound of 1 kHz is generated by the vibrating membrane with a specific surface area vibrating at 1 kHz, and sound of 100 Hz is generated by the vibrating membrane vibrating at 100 Hz. If sound pressure levels (sound pressure levels, SPLs) at the two frequencies are the same, a required air movement at 100 Hz is 100 times that at 1 KHz. In other words, if air movements at the two frequencies are the same, a sound pressure level at 100 Hz is 40 dB lower than that at 1 KHz.

In the conventional electrodynamic speaker, displacement of the vibrating membrane is consistent in a low frequency range before a resonant frequency, and air movements are consistent. Therefore, as an observed frequency doubles, a sound pressure level increases by 12 dB. In other words, as the observed frequency decreases by one time, the sound pressure level decreases by 12 dB. For example, if a sound pressure level of a conventional speaker at 400 Hz is 90 dB under a specific test condition, a sound pressure level of the conventional speaker at 200 Hz is 78 dB under the same test condition. Therefore, the conventional speaker has an obvious bass extension feature. The low frequency drop reaches −12 dB, and a slope is large. As a result, the low frequency sound pressure level of the speaker is too low.

To improve the low frequency sound pressure level of the speaker and improve audio experience, the displacement D of the vibrating membrane or the surface area A of the vibrating membrane needs to be increased. However, increasing the surface area A of the vibrating membrane increases horizontal space of the speaker, and increasing the displacement D of the vibrating membrane increases vertical space of the speaker. The two manners increase a space requirement of the speaker, and consequently the speaker is too large to be stacked into a small electronic product. Therefore, how to improve a low frequency sound pressure level of a speaker based on a limited volume is an urgent problem to be resolved in the industry.

### SUMMARY

This application provides a sound generating apparatus and an electronic device in which the sound generating apparatus is used, where a volume of the sound generating apparatus is small, and a low frequency sound pressure level of generated audible sound is high.

According to a first aspect, this application provides a sound generating apparatus, including a housing, a transducer, a first valve, and a control circuit. The housing has an inner cavity and an opening, the inner cavity of the housing and external space of the housing communicate through the opening of the housing, the transducer is installed in the inner cavity of the housing to divide the inner cavity of the housing into a front cavity and a back cavity, the front cavity is located between the back cavity and the opening, and the first valve is fastened to the housing and covers the opening of the housing.

The control circuit is electrically connected to the transducer and the first valve, the control circuit is configured to generate a first control signal and a second control signal, the first control signal is configured to drive a vibration member of the transducer to vibrate, and the second control signal is configured to control a switch on/off state of the first valve, so that the sound generating apparatus emits a plurality of air pulses to form audible sound. A frequency of the audible sound is lower than a vibration frequency of the vibration member of the transducer, the plurality of air pulses include a positive pulse and a negative pulse, and a sound pressure level of the audible sound varies with proportions of the positive pulse and the negative pulse, or a quantity of positive pulses and a quantity of negative pulses.

The plurality of air pulses form a second sound wave, and the plurality of air pulses of the second sound wave squeeze or relax the air, to cause a density change of the air. A change of an average density of the second sound wave in the air is consistent with a change of an average density of the audible sound. Therefore, the second sound wave forms the audible sound in the air, and the audible sound can be propagated to a human ear. A pulse rate of the second sound wave is higher than the frequency of the expected audible sound. In other words, the second sound wave includes the plurality of air pulses in a single cycle of the audible sound, and these air pulses can fit a waveform of the single cycle of the audible sound.

In this application, the sound generating apparatus no longer uses a conventional speaker structure, but emits the second sound wave including the plurality of air pulses to form the audible sound, and adjusts an amplitude and the frequency of the audible sound by controlling an air pulse density of the second sound wave, to implement audio playback.

In addition, the plurality of air pulses of the second sound wave are implemented by a vibration action of a vibration member of an air pulse generating assembly. The frequency of the audible sound is lower than the pulse rate of the second sound wave. Therefore, the frequency of the audible sound is lower than a vibration frequency of the vibration member. In this case, when audible sound with the same sound pressure level needs to be formed, displacement required for the vibration member to vibrate at the pulse rate of the second sound wave is less than displacement required for the vibration member to vibrate at the frequency of the audible sound. Because the sound generating apparatus emits the second sound wave to form the audible sound, the displacement of the vibration member of the air pulse generating assembly is small. In addition, the sound generating apparatus can adjust the amplitude of the audible sound by adjusting the air pulse density of the second sound wave, and sound pressure level adjustment of the audible sound does not depend on the displacement or a surface area of the vibration member. Therefore, the sound generating apparatus can obtain audible sound of a high sound pressure level through small-displacement vibration of the vibration member of the air pulse generating assembly and by using a large air pulse density of the second sound wave. In this case, a low frequency response of the sound generating apparatus does not exist or the sound generating apparatus hardly has a drop feature, low frequency drop of the sound generating apparatus is clearly lower than 12 dB, and the sound generating apparatus can have a small volume and a high low frequency sound pressure level. The small-volume sound generating apparatus has wider applicability in a scenario with a space requirement.

The sound pressure level of the audible sound is positively correlated with the air pulse density. For example, in a time period, a higher density of a positive pulse indicates a positive sound pressure and a larger amplitude of audible sound in the time period. On the contrary, a higher density of a negative pulse indicates a negative sound pressure and a larger amplitude of the audible sound in the time period. An amplitude of audible sound corresponding to a time period in which the positive pulse and the negative pulse are continuously converted is small, and the amplitude is an absolute value. The density of the positive pulse indicates a difference between a quantity of positive pulses and a quantity of negative pulses in the time period. The density of the negative pulse indicates a difference between the quantity of negative pulses and the quantity of positive pulses in the time period. The air pulse density indicates a difference between a quantity of positive pulses and a quantity of negative pulses in the plurality of air pulses in the time period. The quantity difference is an absolute value.

In addition, because the sound pressure level of the audible sound varies with the air pulse density of the second sound wave, in other words, the amplitude of the audible sound is adjusted by using the air pulse density of the second sound wave, and a change of the frequency of the audible sound is generated due to a change of the amplitude of the audible sound, the frequency of the audible sound can be adjusted by adjusting the air pulse density of the second sound wave.

In this application, the sound pressure level of the audible sound varies with the air pulse density of the second sound wave. A higher air pulse density of the second sound wave indicates a higher sound pressure level of the audible sound, and a lower air pulse density of the second sound wave indicates a lower sound pressure level of the audible sound.

A manner of adjusting the air pulse density includes but is not limited to: in a time period, adjusting proportions of a positive pulse and a negative pulse, and/or adjusting a quantity of positive pulses, and/or adjusting a quantity of negative pulses. The adjusting proportions of a positive pulse and a negative pulse includes: adjusting a proportion of the positive pulse to the negative pulse, or adjusting a proportion of the quantity of positive pulses to a total quantity of air pulses, or adjusting a proportion of the quantity of negative pulses to a total quantity of air pulses. For example, in a time period (for example, a first time period), a larger difference between the quantity of positive pulses and the quantity of negative pulses indicates a higher sound pressure level of the audible sound; and a smaller difference between the quantity of positive pulses and the quantity of negative pulses indicates a lower sound pressure level of the audible sound. The larger difference between the quantity of positive pulses and the quantity of negative pulses includes that the quantity of positive pulses is clearly greater than the quantity of negative pulses, or is clearly less than the quantity of negative pulses. For another example, in a time period (for example, a first time period), if the proportion of the positive pulse to the negative pulse is farther away from 1, the sound pressure level of the audible sound is higher; and if the proportion of the positive pulse to the negative pulse is closer to 1, the sound pressure level of the audible sound is lower.

In some possible implementations, the positive pulse and the negative pulse in the plurality of air pulses have a same sound pressure level. In this case, the sound pressure level of the audible sound is adjusted by adjusting the air pulse density. An amplitude of the first control signal is set to be unchanged, and an amplitude of the vibration member for driving the transducer is unchanged, so that a positive pulse and a negative pulse with unchanged amplitudes are generated. In this case, an operating frequency band of the vibration member of the transducer is a narrow frequency band, and the vibration member only needs to have a relatively high response at a single point. Therefore, the transducer can better use the resonant frequency of the vibration member to implement a response. This improves energy conversion efficiency and helps improve the sound pressure level.

In some other implementations, the sound pressure level of the audible sound may alternatively be adjusted by adjusting the air pulse density and adjusting a sound pressure level of an air pulse. In this case, an adjustable range of the sound pressure level of the audible sound is larger, and the sound generating apparatus has a wider application range and more application scenarios.

In some possible implementations, the second sound wave of the sound generating apparatus is an ultrasonic wave, and the pulse rate of the second sound wave may be higher than 20 kHz. In this case, because the pulse rate of the second sound wave is higher than a highest frequency of the audible sound, the plurality of air pulses of the second sound wave can better fit the waveform of the audible sound, so that the sound pressure level of the audible sound is high and distortion is small. For example, when the frequency of the audible sound belongs to medium and low frequencies (20 Hz to 2000 Hz), a multiple difference between the pulse rate of the second sound wave and the frequency of the audible sound is large, and the second sound wave can form audible sound with a high sound pressure level and low distortion.

In some possible implementations, the second sound wave of the sound generating apparatus may also be an audible sound wave (lower than 20 kHz), and the pulse rate of the second sound wave is a multiple of the frequency of the expected audible sound. For example, when the frequency of the expected audible sound belongs to medium and low frequencies (20 Hz to 2000 Hz), the pulse rate of the second sound wave may be in a range of 10 kHz to 20 kHz, so that the sound pressure level of the audible sound formed by the second sound wave is relatively high and distortion is relatively small.

In some possible implementations, the transducer is configured to generate a first sound wave under driving of the first control signal. The first valve is configured to be switched on and switched off under the control of the second control signal; when the first valve is switched on, a part of the first sound wave generated by the transducer passes through the first valve, to form an air pulse that is emitted to the outside of the sound generating apparatus; and when the first valve is switched off, the first sound wave generated by the transducer is blocked by the first valve, and cannot be propagated to the outside of the sound generating apparatus. The sound generating apparatus selectively emits a part of the first sound wave through cooperation between the transducer and the first valve, to form a plurality of air pulses, thereby forming the second sound wave.

The first sound wave is a basic sound wave of the second sound wave, a frequency of the first control signal is set to an ultrasonic frequency, and the first sound wave is an initial ultrasonic wave, so that a part of the initial ultrasonic wave is selectively emitted through cooperation between the transducer and the first valve, to form the plurality of air pulses. In this case, the second sound wave emitted by the air pulse generating assembly is a modulated ultrasonic wave. In some other embodiments, when the second sound wave is an audible sound wave, the first sound wave may be an audible sound wave or an ultrasonic wave.

In some possible implementations, the frequency of the first control signal is greater than or equal to 20 kHz, and an amplitude of the first control signal remains unchanged. The vibration member of the transducer can perform reciprocating vibration under driving of the first control signal. The vibration frequency of the vibration member is greater than or equal to 20 kHz, that is, the vibration frequency of the vibration member is the ultrasonic frequency. The amplitude of the vibration member remains unchanged. In this case, the initial ultrasonic wave with an unchanged amplitude is formed.

In some possible implementations, the frequency of the second control signal is greater than or equal to twice the frequency of the first control signal. In this case, the first valve can implement selection of a switch on/off state for at least two times during one reciprocating vibration of the vibration member of the air pulse sound generating assembly, the sound generating apparatus can smoothly emit a positive pulse, and/or a negative pulse, and/or a null pulse, and the second sound wave can implement frequency adjustment and amplitude adjustment of the audible sound by adjusting the air pulse density.

In some possible implementations, the frequency of the second control signal is equal to twice the frequency of the first control signal, and a maximum density of the positive pulse is the same as the frequency of the first control signal.

In some possible implementations, the sound generating apparatus further includes a second valve, the second valve is disposed on the transducer or the housing, and when the second valve is switched on, the front cavity communicates with the back cavity. When the second valve is switched on, acoustic communication between the front cavity and the back cavity is formed. In some possible implementations, the control circuit is electrically connected to the second valve, and the control circuit is further configured to generate a third control signal. In a process of the reciprocating vibration of the vibration member of the air pulse generating assembly of the transducer, the second valve may be switched on according to any rule, to implement pressure balance between the front cavity and the back cavity. A switch on/off moment, switch on/off duration, and a switch on/off state switching frequency of the second valve are set flexibly, and the third control signal is less limited by the first control signal and the second control signal.

The third control signal is used to control a switch on cycle of the second valve to be less than or equal to 20 times a cycle of the first control signal, to ensure that pressure states of the front cavity and the back cavity of the air pulse generating assembly can meet a basic requirement of smooth vibration of the vibration member, and reduce a degree of vibration distortion of the vibration member.

A minimum width of an acoustic flow channel when the second valve is switched on is greater than a thickness d_{μ} of a viscous layer, and the thickness of the viscous layer is

$${d}_{μ} = 0.22 mm ⋆ \sqrt{\frac{100 Hz}{f}} ,$$

where f indicates the frequency of the first control signal. The minimum width of the acoustic flow channel is a size of a narrowest position of the acoustic flow channel. In this embodiment, when the second valve is switched on, acoustic communication between the front cavity and the back cavity is formed.

In some possible implementations, the transducer or the housing is provided with a communicating hole, and the front cavity and the back cavity communicate through the communicating hole. The communicating hole is configured to implement air pressure balance between the front cavity and the back cavity, so that the transducer can vibrate smoothly, to form the first sound wave with a small degree of distortion under driving of the first control signal.

A minimum width of the communicating hole is greater than a thickness d_{μ} of a viscous layer, and the thickness of the viscous layer is

$${d}_{μ} = 0.22 mm ⋆ \sqrt{\frac{100 Hz}{f}} ,$$

where f is the frequency of the first control signal. The minimum width of the communicating hole is a size of a narrowest position of a single communicating hole.

In some possible implementations, the front cavity and the back cavity do not communicate with each other. In an operating process of the air pulse generating assembly, the front cavity and the back cavity are always separated and do not communicate. The housing is provided with a front ventilation port, and the front cavity of the housing and the external space of the housing communicate through the front ventilation port. By disposing the front ventilation port, pressure balance between the front cavity of the housing and the external space of the housing is maintained, so that the vibration member of the transducer can vibrate smoothly, to form a sound wave.

The sound generating apparatus may further be provided with a second acoustic mesh. The second acoustic mesh may be fastened to the housing in a manner of bonding or the like, and cover the front ventilation port. The second acoustic mesh is ventilated, so that the air pulse generating assembly can still implement air pressure balance between the front cavity and the external space of the housing through the front ventilation port. In addition, the second acoustic mesh can implement acoustic isolation between the front cavity and the external space of the housing, so that a sound wave in the front cavity does not leak into the external space of the housing. A quantity, shapes, or the like of second acoustic meshes are adapted to the front ventilation port. In some other embodiments, the sound generating apparatus may not be provided with the second acoustic mesh.

In some possible implementations, the housing is provided with a back ventilation port, and the back cavity of the housing and the external space of the housing communicate through the back ventilation port. The back ventilation port is configured to implement air balance between the back cavity and the external space of the housing.

The sound generating apparatus may further be provided with a first acoustic mesh. The first acoustic mesh may be fastened to the housing in a manner of bonding or the like, and cover the back ventilation port. The first acoustic mesh is ventilated, so that the air pulse generating assembly can still implement air pressure balance between the back cavity and the external space of the housing through the back ventilation port. In addition, the first acoustic mesh can implement acoustic isolation between the back cavity and the external space of the housing, so that a sound wave in the back cavity does not leak into the external space of the housing. Ventilation means that media on two sides of an interface can be exchanged, and acoustic isolation means that sound cannot penetrate. A quantity, shapes, or the like of first acoustic meshes are adapted to the back ventilation port. In some other implementations, the sound generating apparatus may not be provided with the first acoustic mesh.

In some possible implementations, the frequency of the first control signal is less than 400 kHz, so that the sound generating apparatus generates audible sound with a frequency in a range of 20 Hz to 2 kHz. In this case, the frequency design of the first control signal can make the degree of distortion of the second sound wave relatively low and the sound pressure level of the audible sound relatively high.

In some possible implementations, the frequency of the first control signal is greater than or equal to 400 kHz, so that the sound generating apparatus generates audible sound with a frequency in a range of 20 Hz to 20 kHz. In this case, the frequency design of the first control signal can make the degree of distortion of the second sound wave relatively low and the sound pressure level of the audible sound relatively high.

In some possible implementations, because the transducer is configured to perform reciprocating vibration to generate the first sound wave, and the first sound wave is a single-frequency sound wave, the resonant frequency of the vibration member of the transducer is set to be the same as or close to the frequency of the expected first sound wave, that is, the same as or close to the frequency of the first control signal. This can improve a response degree of the vibration member of the transducer to the first control signal, and energy utilization is high, which helps improve the sound pressure level of the audible sound. When the vibration member of the transducer is of a piezoelectric structure, a high Q value feature of the piezoelectric structure may be used for driving, to improve energy conversion efficiency, so that energy utilization of the transducer is high. A Q value is called a quality factor, and a high Q value means a low sound wave energy loss (an attenuation rate is directly proportional to a square of a frequency).

In some possible implementations, the transducer includes a support, a vibrating membrane, and a piezoelectric sheet. A peripheral edge of the vibrating membrane is fastened to the support. The piezoelectric sheet is fastened to a middle part of the vibrating membrane. The piezoelectric sheet may be a single crystal piezoelectric sheet or a double crystal piezoelectric sheet. A resonant frequency of a vibration member formed by the vibrating membrane and the piezoelectric sheet is less than 400 kHz.

In some possible implementations, the transducer includes a support and a piezoelectric sheet. The piezoelectric sheet is fastened to the support. The piezoelectric sheet may be a single crystal piezoelectric sheet or a double crystal piezoelectric sheet. A resonant frequency of the piezoelectric sheet is greater than or equal to 400 kHz.

In some possible implementations, the transducer includes a support, a vibrating membrane, and a plurality of piezoelectric sheets. A peripheral edge of the vibrating membrane is fastened to the support. The plurality of piezoelectric sheets are fastened to a middle part of the vibrating membrane. Resonant frequencies of the plurality of piezoelectric sheets are the same. A resonant frequency of a vibration member formed by the vibrating membrane and the plurality of piezoelectric sheets is greater than or equal to 400 kHz.

In some possible implementations, the vibration member of the transducer includes a substrate and a plurality of piezoelectric components. The substrate is made of a polymer material. The plurality of piezoelectric components are embedded in the substrate. A resonant frequency of the vibration member is greater than or equal to 400 kHz.

In some possible implementations, the transducer is a polyvinylidene fluoride piezoelectric film transducer, a capacitive micromachined transducer, or a piezoelectric micromachined transducer. A resonant frequency of the vibration member of the transducer is greater than or equal to 400 kHz.

In some possible implementations, the sound generating apparatus includes a plurality of transducers, and the plurality of transducers are all installed in the inner cavity of the housing and located between the front cavity and the back cavity. Resonant frequencies of vibration members of the plurality of transducers are the same and are all greater than or equal to 400 KHz.

In some possible implementations, the frequency of the first control signal is the same as the resonant frequency of the vibration member of the transducer, so that a matching degree between the first sound wave and the first control signal is high, thereby helping improve a sound pressure level that can be improved.

In some possible implementations, the transducer includes the vibration member, and the vibration member is configured to perform reciprocating motion under driving of the first control signal to generate the first sound wave. The first sound wave may be the ultrasonic wave or the audible sound wave.

In some possible implementations, a distance between the first valve and the vibration member is less than λ/2 in a vertical direction of the vibration member, and A is a wavelength of the first sound wave. In this embodiment, the distance between the first valve and the vibration member affects a phase delay of the first sound wave. By setting the distance between the first valve and the vibration member to be less than λ/2, a loss of the first sound wave during transmission in the front cavity can be reduced, to improve problems that the second sound wave is prone to generate distortion, energy loss is large, and the like, improve energy conversion efficiency of the air pulse generating assembly, and help improve the sound pressure level of the audible sound.

In some possible implementations, a height of the back cavity is in a range of M*λ+λ/4−λ/8 to M*λ+λ/4+λ/8 in the vertical direction of the vibration member, λ is the wavelength of the first sound wave, and M is a natural number. In this embodiment, a phase of a back cavity reflection sound wave is the same as or close to a phase of the first sound wave, and superposition of the back cavity reflection sound wave and the first sound wave generates an enhancement effect, to help improve the sound pressure level of the audible sound. For example, the height H2 of the back cavity may be in a range of M*λ+λ/4−λ/9 to M*λ+λ/4+λ/9, or in a range of M*λ+λ/4−λ/10 to M*λ+λ/4+λ/10, to obtain a better sound wave superposition effect and a higher sound pressure level of the audible sound.

For example, the height H2 of the back cavity is outside a range of M*λ+λ/2−λ/8 to M*λ+λ/2+λ/8 in the vertical direction of the vibration member, to avoid a cancellation problem caused by the superposition of the back cavity reflection sound wave and the first sound wave, and reduce distortion of the second sound wave. For example, the height H2 of the back cavity is as far as possible outside a range of M*λ+λ/2−λ/9 to M*λ+λ/2+λ/9, or outside a range of M*λ+λ/2−λ/10 to M*λ+λ/2+λ/10.

In some possible implementations, the sound generating apparatus is further provided with a sound-absorbing member, and the sound-absorbing member is installed in the back cavity. The sound-absorbing member may be sound-absorbing cotton, a local resonance sound-absorbing structure, another sound-absorbing structure, or the like. By deposing the sound-absorbing member, the first sound wave emitted by the vibration member to the back cavity may be weakened or eliminated, to weaken or eliminate the back cavity reflection sound wave, reduce impact of the back cavity reflection sound wave on the second sound wave, and improve a sound pressure level of the audible sound. Through simulation calculation, the sound pressure level of the audible sound is improved by more than 3 dB and the distortion is reduced after the sound-absorbing member is added to the air pulse generating assembly.

In some possible implementations, a height of the back cavity is less than λ/4 in the vertical direction of the vibration member. In this case, the sound-absorbing member is disposed on the back cavity of the air pulse generating assembly, to weaken or eliminate the back cavity reflection sound wave to reduce distortion of the second sound wave, and make the height of the back cavity less than λ/4 to reduce an overall height of the air pulse generating assembly, which helps miniaturization of the air pulse generating assembly and the sound generating apparatus.

In some possible implementations, the sound generating apparatus further includes a signal processing circuit. The signal processing circuit is configured to convert an audio signal into a target air pulse signal according to a pulse density modulation algorithm. The control circuit is configured to generate the first control signal and the second control signal based on the target air pulse signal.

In the pulse density modulation algorithm, an amplitude of the audio signal is represented by using a density of a region corresponding to the target air pulse signal. The target air pulse signal carries related information of a target air pulse, and the target air pulse is used to form a sound wave corresponding to the audio signal. The target air pulse signal may include at least one of a positive pulse signal, a null pulse signal, and a negative pulse signal. The positive pulse signal corresponds to a positive pulse in the target air pulse, the negative pulse signal corresponds to a negative pulse in the target air pulse, and the null pulse signal corresponds to a null pulse in the target air pulse. In some embodiments, the target air pulse signal may alternatively not include the null pulse signal. When the target air pulse signal includes the positive pulse signal and the negative pulse signal, or when the target air pulse signal includes the positive pulse signal, the null pulse signal, and the negative pulse signal, a higher density of the positive pulse signal indicates that an audio signal corresponding to the region is positive and has a larger amplitude; on the contrary, a higher density of the negative pulse signal indicates that the audio signal corresponding to the region is negative and has a larger amplitude; and an amplitude of an audio signal corresponding to a region in which the positive pulse signal and the negative pulse signal are continuously converted is small, and the amplitude is an absolute value. The density of the positive pulse signal indicates a quantity of positive pulse signals in a time period. The density of the negative pulse signal indicates a quantity of positive pulse signals in the time period.

According to a second aspect, this application further provides an electronic device, including the sound generating apparatus according to any one of the foregoing implementations. Audible sound generated by the electronic device has a high sound pressure level.

### BRIEF DESCRIPTION OF DRAWINGS

FIG. 1 is a block diagram of a sound generating apparatus according to an embodiment of this application in some embodiments;

FIG. 2 is a first diagram of a sound generating principle of the sound generating apparatus shown in FIG. 1;

FIG. 3 is a second diagram of a sound generating principle of the sound generating apparatus shown in FIG. 1;

FIG. 4 is a diagram of a structure of an air pulse generating assembly of the sound generating apparatus shown in FIG. 1 in some embodiments;

FIG. 5 is a diagram of the sound generating apparatus shown in FIG. 1 in some usage statuses;

FIG. 6 is a diagram of an internal structure of the air pulse generating assembly shown in FIG. 4 in some usage statuses;

FIG. 7 is a diagram of an internal structure of the air pulse generating assembly shown in FIG. 4 in some other usage statuses;

FIG. 8 is a diagram of the sound generating apparatus shown in FIG. 1 in some other usage statuses;

FIG. 9 is a diagram of an internal structure of the air pulse generating assembly shown in FIG. 4 in some usage statuses;

FIG. 10 is a diagram of an internal structure of the air pulse generating assembly shown in FIG. 4 in some other usage statuses;

FIG. 11 is a diagram of the sound generating apparatus shown in FIG. 1 in some other usage statuses;

FIG. 12 is a diagram of a first modulation rule of the sound generating apparatus shown in FIG. 1;

FIG. 13 is a diagram of a second modulation rule of the sound generating apparatus shown in FIG. 1;

FIG. 14 is a diagram of a third modulation rule of the sound generating apparatus shown in FIG. 1;

FIG. 15 is a diagram of a fourth modulation rule of the sound generating apparatus shown in FIG. 1;

FIG. 16 is a diagram of an internal structure of the air pulse generating assembly shown in FIG. 4;

FIG. 17 is a diagram of an internal structure of the air pulse generating assembly shown in FIG. 1 in some other embodiments;

FIG. 18 is a diagram of an internal structure of the air pulse generating assembly shown in FIG. 1 in some other embodiments;

FIG. 19 is a diagram of an internal structure of the air pulse generating assembly shown in FIG. 18;

FIG. 20 is a diagram of an internal structure of the air pulse generating assembly shown in FIG. 1 in some other embodiments;

FIG. 21 is a diagram of an internal structure of the air pulse generating assembly shown in FIG. 1 in some other embodiments;

FIG. 22 is a diagram of an internal structure of the air pulse generating assembly shown in FIG. 1 in some other embodiments;

FIG. 23 is a diagram of a structure of an ultrasonic transducer according to an embodiment of this application in some embodiments;

FIG. 24 is a diagram of a structure of an ultrasonic transducer according to an embodiment of this application in some other embodiments;

FIG. 25 is a diagram of a structure of an ultrasonic transducer according to an embodiment of this application in some other embodiments;

FIG. 26 is a diagram of a structure of an ultrasonic transducer according to an embodiment of this application in some other embodiments;

FIG. 27 is a diagram of a partial structure of the ultrasonic transducer shown in FIG. 26;

FIG. 28 is a diagram of a structure of an ultrasonic transducer according to an embodiment of this application in some other embodiments;

FIG. 29 is a diagram of a partial structure of the ultrasonic transducer shown in FIG. 28;

FIG. 30 is a diagram of a structure of the air pulse generating assembly shown in FIG. 1 in some other embodiments; and

FIG. 31 is a diagram of a partial structure of the air pulse generating assembly shown in FIG. 30.

### DESCRIPTION OF EMBODIMENTS

The following describes technical solutions of embodiments in this application with reference to the accompanying drawings. In the descriptions of embodiments of this application, unless otherwise specified, “/” indicates “or”. For example, A/B may indicate A or B. The term “and/or” in this specification merely describes an association relationship between associated objects, and indicates that three relationships may exist. For example, A and/or B may indicate the following three cases: Only A exists, both A and B exist, and only B exists. In addition, in the descriptions of embodiments of this application, “a plurality of” means two or more.

In the following, terms such as “first” and “second” are used only for description purposes, and cannot be understood as implying or implying relative importance or implicitly indicating a quantity of indicated technical features. Therefore, a feature limited by “first” or “second” may explicitly or implicitly include one or more features.

Orientation terms mentioned in embodiments of this application, for example, “on”, “below”, “inside”, “outside”, “side”, “top”, and “bottom”, are merely directions based on the accompanying drawings. Therefore, the orientation terms are used to better and more clearly describe and understand embodiments of this application, instead of indicating or implying that a specified apparatus or element needs to have a specific orientation, and be constructed and operated in the specific orientation. Therefore, this cannot be understood as a limitation on embodiments of this application.

In the descriptions of embodiments of this application, it should be noted that, unless otherwise specified and limited, terms “installation”, “being connected to”, “connection”, and “being disposed on” should be understood in a broad sense. For example, “connection” may be a detachable connection, a nondetachable connection, a direct connection, or an indirect connection through an intermediate medium. “Electrical connection” means that an electrical signal may be conducted between two ends.

Embodiments of this application provide a sound generating apparatus and an electronic device in which the sound generating apparatus is used. The sound generating apparatus uses a sound generating method different from that of a conventional speaker. The sound generating apparatus emits a plurality of air pulses to form audible sound. A frequency of the audible sound is lower than a vibration frequency of a transducer of the sound generating apparatus. A sound pressure level of the audible sound is adjusted by using an air pulse density of the plurality of air pulses, so that the sound generating apparatus has a high low frequency sound pressure level based on a small volume. The electronic device may be an electronic device that needs to output audio by using the sound generating apparatus, for example, a mobile phone, a tablet, a hearing aid, or a smart wearable device. The smart wearable device may be a smartwatch, augmented reality (augmented reality, AR) glasses, an AR helmet, virtual reality (virtual reality, VR) glasses, or the like. The sound generating apparatus may further be used in the fields of a whole house, a smart home, automobiles, or the like, and serve as an audio device or a part of the audio device.

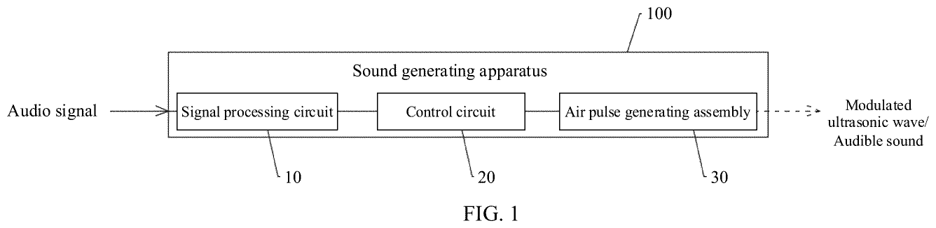

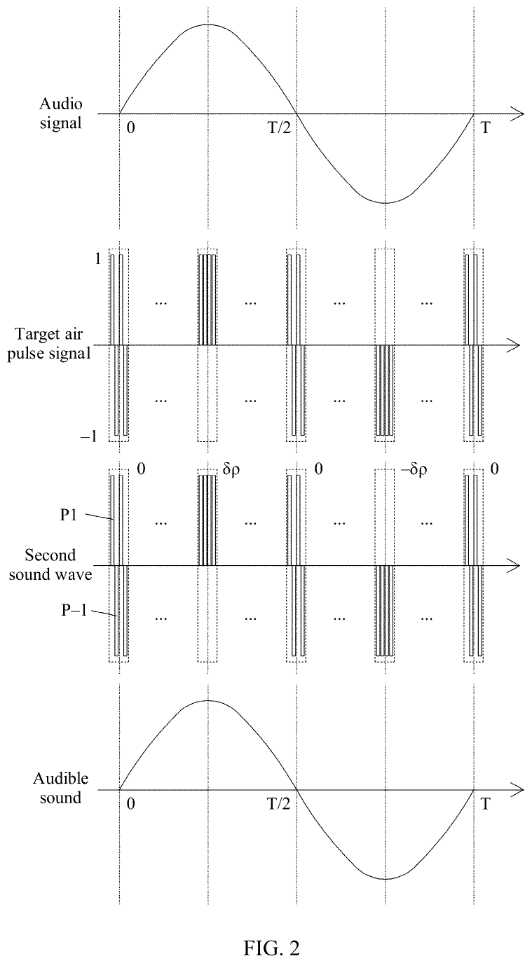

FIG. 1 is a block diagram of a sound generating apparatus 100 according to an embodiment of this application in some embodiments. FIG. 2 is a first diagram of a sound generating principle of the sound generating apparatus 100 shown in FIG. 1.

In some embodiments, the sound generating apparatus 100 includes a signal processing circuit 10, a control circuit 20, and an air pulse generating assembly 30. The signal processing circuit 10 is configured to convert an audio signal into a target air pulse signal. In some embodiments, the signal processing circuit 10 may convert the audio signal into the target air pulse signal according to a pulse density modulation (Pulse Density Modulation, PDM) algorithm. The audio signal may be output by a sound source. The audio signal may be a digital signal or an analog signal. When the audio signal is the analog signal, the audio signal may be converted into a digital signal by an analog-to-digital conversion circuit. The analog-to-digital conversion circuit may be a part of the signal processing circuit 10, or may be another circuit independent of the signal processing circuit 10. This is not strictly limited in embodiments of this application. The control circuit 20 is configured to generate a control signal based on the target air pulse signal, and the air pulse generating assembly 30 is configured to emit a plurality of air pulses based on the control signal, to form audible sound.

The sound generating apparatus 100 may be a modular assembly. The signal processing circuit 10 and the control circuit 20 of the sound generating apparatus 100 may be integrated into a circuit assembly of the sound generating apparatus 100. The circuit assembly may usually include one or more circuit boards, one or more chips, and matching elements thereof. Alternatively, in some embodiments, when the sound generating apparatus 100 is used in the electronic device, the signal processing circuit 10 and/or the control circuit 20 of the sound generating apparatus 100 may be fastened to or integrated into another component of the electronic device. This is not strictly limited in embodiments of this application.

In the pulse density modulation algorithm, an amplitude of the audio signal is represented by using a density of a region corresponding to the target air pulse signal. The target air pulse signal carries related information of a target air pulse, and the target air pulse is used to form a sound wave corresponding to the audio signal. The target air pulse signal may include at least one of a positive pulse signal, a null pulse signal, and a negative pulse signal. The positive pulse signal corresponds to a positive pulse in the target air pulse, the negative pulse signal corresponds to a negative pulse in the target air pulse, and the null pulse signal corresponds to a null pulse in the target air pulse. In some embodiments, the target air pulse signal may alternatively not include the null pulse signal. In the embodiment shown in FIG. 2, the positive pulse signal and the negative pulse signal are respectively indicated by 1 and −1. In some other cases, the positive pulse signal and the negative pulse signal may alternatively be respectively indicated by 1 and 0.

When the target air pulse signal includes the positive pulse signal and the negative pulse signal, or when the target air pulse signal includes the positive pulse signal, the null pulse signal, and the negative pulse signal, a higher density of the positive pulse signal indicates that an audio signal corresponding to the region is positive and has a larger amplitude; on the contrary, a higher density of the negative pulse signal indicates that the audio signal corresponding to the region is negative and has a larger amplitude; and an amplitude of an audio signal corresponding to a region in which the positive pulse signal and the negative pulse signal are continuously converted is small, and the amplitude is an absolute value. The density of the positive pulse signal indicates a quantity of positive pulse signals in a time period (namely, in a time window shown by using a dashed box in FIG. 2). The density of the negative pulse signal indicates a quantity of positive pulse signals in a time period (namely, in a time window).

The air pulse generating assembly 30 generates a second sound wave based on the control signal, where the second sound wave includes a plurality of air pulses, and the air pulses have a specific sound pressure level, so that the second sound wave forms the audible sound. The plurality of air pulses of the second sound wave squeeze or relax the air, to cause a density change of the air. A change of an average density of the second sound wave in the air is consistent with a change of an average density of the audible sound. Therefore, the second sound wave forms the audible sound in the air, and the audible sound can be propagated to a human ear. A pulse rate of the second sound wave is higher than the frequency of the expected audible sound. In other words, the second sound wave includes the plurality of air pulses in a single cycle of the audible sound and these air pulses can fit a waveform of the single cycle of the audible sound. For example, the pulse rate of the second sound wave is 40 kHz, and the frequency of the expected audible sound is 100 Hz. Herein, “average density” is an average density of the air at a location in space in a time period, or an average density of the air at a moment in time in a space range.

For example, in the embodiment shown in FIG. 2, the plurality of air pulses of the second sound wave include a positive pulse (positive pulse) P1, a null pulse (null pulse) P0 (which coincides with a coordinate axis and is not marked in the figure), and a negative pulse (negative pulse) P-1. The positive pulse P1 and the negative pulse P-1 have a same amplitude. In some embodiments, the sound pressure level (for example, corresponding to a waveform amplitude in FIG. 2) of the audible sound is positively correlated with an air pulse density. For example, in a time period, a higher density of the positive pulse P1 indicates a positive sound pressure and a larger amplitude of audible sound in the time period. On the contrary, a higher density of the negative pulse P-1 indicates a negative sound pressure and a larger amplitude of the audible sound in the time period. An amplitude of audible sound corresponding to a time period in which the positive pulse P1 and the negative pulse P-1 are continuously converted is small, and the amplitude is an absolute value. The density of the positive pulse P1 indicates a difference between a quantity of positive pulses and a quantity of negative pulses in a time period (namely, in a time window shown by using a dashed box in FIG. 2). The density of the negative pulse indicates a difference between a quantity of negative pulses and a quantity of positive pulses in a time period (namely, in a time window). The air pulse density indicates a difference between a quantity of positive pulses and a quantity of negative pulses in the plurality of air pulses in a time period. The quantity difference is an absolute value.

For example, a width of a time window may be about 1/20 kHz, that is, close to a cycle of a highest frequency of the audible sound. Certainly, the width of the time window may alternatively be other duration. This is not strictly limited in embodiments of this application. A single time window usually includes a plurality of air pulses.

In addition, because the sound pressure level of the audible sound varies with the air pulse density of the second sound wave, in other words, the amplitude of the audible sound is adjusted by using the air pulse density of the second sound wave, and a change of the frequency of the audible sound is generated due to a change of the amplitude of the audible sound, the frequency of the audible sound can be adjusted by adjusting the air pulse density of the second sound wave.

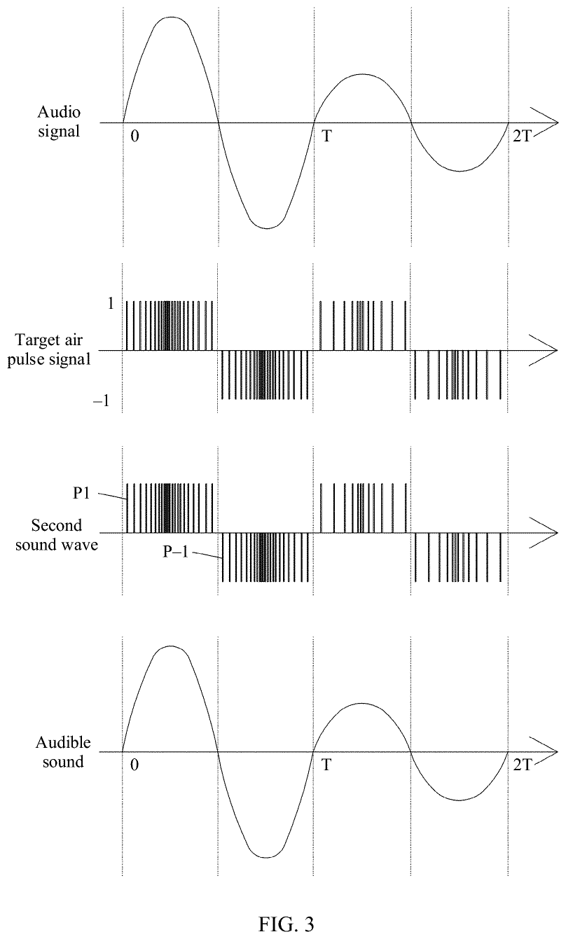

FIG. 3 is a second diagram of a sound generating principle of the sound generating apparatus 100 shown in FIG. 1.

For example, a larger amplitude of the audio signal indicates a higher density of the positive pulse signal or the negative pulse signal in the corresponding target air pulse signal. In the second sound wave correspondingly formed by the air pulse generating assembly 30, a higher air pulse density indicates a larger waveform amplitude of the formed audible sound and a higher sound pressure level of the audible sound.

As shown in FIG. 2 and FIG. 3, in embodiments of this application, the sound pressure level of the audible sound varies with the air pulse density of the second sound wave. A higher air pulse density of the second sound wave indicates a higher sound pressure level of the audible sound, and a lower air pulse density of the second sound wave indicates a lower sound pressure level of the audible sound.

A manner of adjusting the air pulse density includes but is not limited to: in a time period, adjusting proportions of a positive pulse and a negative pulse, and/or adjusting a quantity of positive pulses, and/or adjusting a quantity of negative pulses. The adjusting proportions of a positive pulse and a negative pulse includes: adjusting a proportion of the positive pulse to the negative pulse, or adjusting a proportion of the quantity of positive pulses to a total quantity of air pulses, or adjusting a proportion of the quantity of negative pulses to a total quantity of air pulses. For example, in a time period (for example, a first time period), a larger difference between the quantity of positive pulses and the quantity of negative pulses indicates a higher sound pressure level of the audible sound; and a smaller difference between the quantity of positive pulses and the quantity of negative pulses indicates a lower sound pressure level of the audible sound. The larger difference between the quantity of positive pulses and the quantity of negative pulses includes that the quantity of positive pulses is clearly greater than the quantity of negative pulses, or is clearly less than the quantity of negative pulses. For another example, in a time period (for example, a first time period), if the proportion of the positive pulse to the negative pulse is farther away from 1, the sound pressure level of the audible sound is higher; and if the proportion of the positive pulse to the negative pulse is closer to 1, the sound pressure level of the audible sound is lower.

For example, the positive pulse P1 and the negative pulse P-1 in the plurality of air pulses of the second sound wave have a same sound pressure level, that is, have a same amplitude. In this case, the sound pressure level of the audible sound is adjusted by adjusting the air pulse density. In some other embodiments, the sound pressure level of the audible sound may alternatively be adjusted by adjusting the air pulse density and adjusting a sound pressure level of an air pulse. In this case, an adjustable range of the sound pressure level of the audible sound is larger, and the sound generating apparatus has a wider application range and more application scenarios.

In some embodiments, the second sound wave of the sound generating apparatus 100 is an ultrasonic wave, and the pulse rate of the second sound wave may be higher than 20 kHz. In this case, because the pulse rate of the second sound wave is higher than a highest frequency of the audible sound, the plurality of air pulses of the second sound wave can better fit the waveform of the audible sound, so that the sound pressure level of the audible sound is high and distortion is small. For example, when the frequency of the audible sound belongs to medium and low frequencies (20 Hz to 2000 Hz), a multiple difference between the pulse rate of the second sound wave and the frequency of the audible sound is large, and the second sound wave can form audible sound with a high sound pressure level and low distortion.

In some other embodiments, the second sound wave of the sound generating apparatus 100 may alternatively be an audible sound wave (lower than 20 kHz), and the pulse rate of the second sound wave is a multiple of the frequency of the expected audible sound. For example, when the frequency of the expected audible sound belongs to medium and low frequencies (20 Hz to 2000 Hz), the pulse rate of the second sound wave may be in a range of 10 kHz to 20 kHz, so that the sound pressure level of the audible sound formed by the second sound wave is relatively high and distortion is relatively small.

In conclusion, in embodiments of this application, the sound generating apparatus 100 no longer uses a conventional speaker structure, but emits the second sound wave including the plurality of air pulses to form the audible sound, and adjusts the amplitude and the frequency of the audible sound by controlling the air pulse density of the second sound wave, to implement audio playback. In addition, the plurality of air pulses of the second sound wave are implemented by a vibration action of a vibration member of the air pulse generating assembly 30. The frequency of the audible sound is lower than the pulse rate of the second sound wave. Therefore, the frequency of the audible sound is lower than a vibration frequency of the vibration member. In this case, when audible sound with the same sound pressure level needs to be formed, displacement required for the vibration member to vibrate at the pulse rate of the second sound wave is less than displacement required for the vibration member to vibrate at the frequency of the audible sound. Because the sound generating apparatus 100 emits the second sound wave to form the audible sound, the displacement of the vibration member of the air pulse generating assembly 30 is small. In addition, the sound generating apparatus 100 can adjust the amplitude of the audible sound by adjusting the air pulse density of the second sound wave, and sound pressure level adjustment of the audible sound does not depend on the displacement or a surface area of the vibration member. Therefore, the sound generating apparatus 100 can obtain audible sound of a high sound pressure level through small-displacement vibration of the vibration member of the air pulse generating assembly 30 and by using the large air pulse density of the second sound wave. In this case, a low frequency response of the sound generating apparatus 100 does not exist or the sound generating apparatus 100 hardly has a drop feature, low frequency drop of the sound generating apparatus 100 is clearly lower than 12 dB, and the sound generating apparatus 100 can have a small volume and a high low frequency sound pressure level. The small-volume sound generating apparatus 100 has wider applicability in a scenario with a space requirement.

The following describes a part of the structure and a part of the operating principle of the sound generating apparatus 100 by using an example in which the second sound wave emitted by the sound generating apparatus 100 is an ultrasonic wave, for example, a modulated ultrasonic wave.

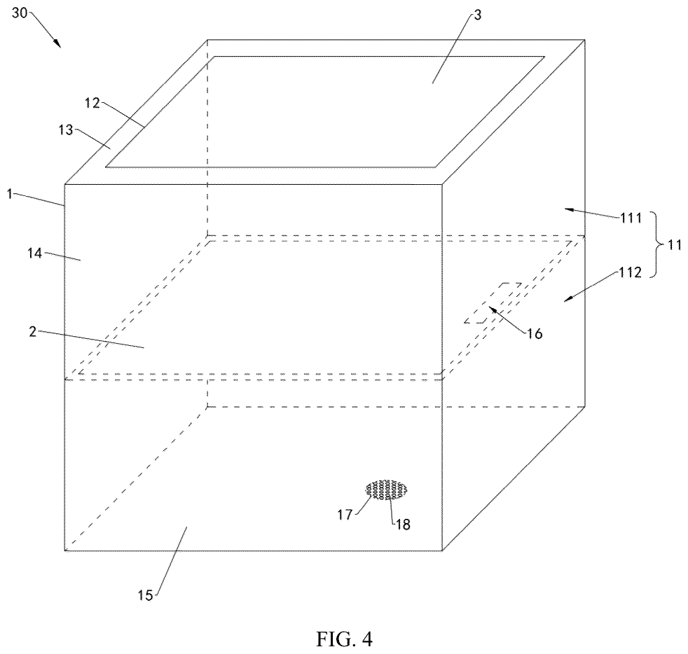

FIG. 4 is a diagram of a structure of the air pulse generating assembly 30 of the sound generating apparatus 100 shown in FIG. 1 in some embodiments.

In some embodiments, the air pulse generating assembly 30 of the sound generating apparatus 100 includes a housing 1, a transducer, and a first valve 3. In this embodiment, an example in which the transducer is an ultrasonic transducer (ultrasonic transducer) 2 is used for description. The housing 1 has an inner cavity 11 and an opening 12, and the inner cavity 11 of the housing 1 and external space of the housing 1 communicate through the opening 12 of the housing 1. For example, the housing 1 may include a top wall 13, a bottom wall 14, and side walls 15. The top wall 13 and the bottom wall 14 are disposed opposite to each other, the side walls 15 are located between the top wall 13 and the bottom wall 14, and the top wall 13, the bottom wall 14, and the side walls 15 jointly enclose the inner cavity 11. The top wall 13 is provided with the opening 12. The ultrasonic transducer 2 is installed in the inner cavity 11 of the housing 1 to divide the inner cavity 11 of the housing 1 into a front cavity 111 and a back cavity 112. The front cavity 111 is located between the back cavity 112 and the opening 12. The back cavity 112 is located between the bottom wall 14 and the ultrasonic transducer 2, and the front cavity 111 is located between the ultrasonic transducer 2 and the opening 12. The first valve 3 is fastened to the housing 1 and covers the opening 12 of the housing 1. In some other embodiments, the housing 1 may not include the top wall 13, ends on one side of the side walls 15 are connected to a peripheral edge of the bottom wall 14, the bottom wall 14 and the side walls 15 jointly enclose the inner cavity 11 of the housing 1, and ends on the other side of the side walls 15 form the opening 12 of the housing 1.

The first valve 3 may use a piezoelectric structure. For example, the first valve 3 includes a piezoelectric sheet, where one end of the piezoelectric sheet is a fixed end relative to the housing 1, and the other end is a movable end relative to the housing 1. When the piezoelectric sheet is powered off, the piezoelectric sheet covers the opening 12 to implement switch off. When the piezoelectric sheet is powered on, the piezoelectric sheet deforms, and the movable end of the piezoelectric sheet is tilted, pressed, shifted, or the like, to uncover the opening 12, so as to implement switch on. Certainly, the first valve 3 may further have another piezoelectric structure, or the first valve 3 may also use another non-piezoelectric structure. This is not strictly limited in embodiments of this application.

The ultrasonic transducer 2 is configured to generate a first sound wave under driving of a first control signal. The first valve 3 is configured to be switched on and switched off under the control of a second control signal; when the first valve 3 is switched on, a part of the first sound wave generated by the ultrasonic transducer 2 passes through the first valve 3, to form an air pulse that is emitted to the outside of the sound generating apparatus 100; and when the first valve 3 is switched off, the first sound wave generated by the ultrasonic transducer 2 is blocked by the first valve 3, and cannot be propagated to the outside of the sound generating apparatus 100. The sound generating apparatus 100 selectively emits a part of the first sound wave through cooperation between the ultrasonic transducer 2 and the first valve 3 to form a plurality of air pulses, thereby forming the second sound wave.

The first sound wave is a basic sound wave of the second sound wave, a frequency of the first control signal is set to an ultrasonic frequency, and the first sound wave is an initial ultrasonic wave, so that a part of the initial ultrasonic wave is selectively emitted through cooperation between the ultrasonic transducer 2 and the first valve 3, to form the plurality of air pulses. In this case, the second sound wave emitted by the air pulse generating assembly 30 is a modulated ultrasonic wave. In some other embodiments, when the second sound wave is an audible sound wave, the first sound wave may be an audible sound wave or an ultrasonic wave.

For example, the control circuit 20 is electrically connected to the ultrasonic transducer 2 and the first valve 3. The control circuit 20 is configured to generate the first control signal and the second control signal. The first control signal is used to drive the ultrasonic transducer 2 to vibrate. In some embodiments, the frequency of the first control signal may be greater than or equal to 20 kHz, and an amplitude of the first control signal remains unchanged. The vibration member of the ultrasonic transducer 2 can perform reciprocating vibration under driving of the first control signal. The vibration frequency of the vibration member is greater than or equal to 20 kHz, that is, the vibration frequency of the vibration member is the ultrasonic frequency. The amplitude of the vibration member remains unchanged. In this case, the initial ultrasonic wave with an unchanged amplitude is formed. The second control signal is used to control a switch on/off state of the first valve 3, so that the sound generating apparatus 100 can selectively emit a part of the initial ultrasonic wave to form the modulated ultrasonic wave including the plurality of air pulses, and the modulated ultrasonic wave forms the audible sound. In this case, the frequency of the audible sound is lower than the vibration frequency of the vibration member of the ultrasonic transducer 2. The first control signal may include one or more signals, the second control signal may include one or more signals, and the first control signal and the second control signal are different signals.

In this application, the type of the air pulse of the modulated ultrasonic wave may include a positive pulse P1, a null pulse P0, and a negative pulse P-1. There are a plurality of implementations for a plurality of pulse types. Examples are described below.

### First Implementation

In a process of reciprocating vibration of the vibration member of the ultrasonic transducer 2, in a time period in which the vibration member moves upward from a balance position and then returns to the balance position, the first valve 3 is switched on, air in the front cavity 111 is pushed into the external space of the housing 1, and the ultrasonic transducer 2 generates the positive pulse P1. In a time period in which the vibration member moves downward from the balance position and then returns to the balance position, the first valve 3 is switched on, air in the external space of the housing 1 is sucked into the front cavity 111, and the ultrasonic transducer 2 generates the negative pulse P-1. In the process of reciprocating vibration of the vibration member, the first valve 3 is switched off, and the ultrasonic transducer 2 generates the null pulse P0. The null pulse P0 may also be understood as not generating an air pulse having an amplitude. In this embodiment of this application, the upward movement of the vibration member means that the vibration member moves in a direction close to the first valve 3, and the downward movement of the vibration member means that the vibration member moves in a direction away from the first valve 3.

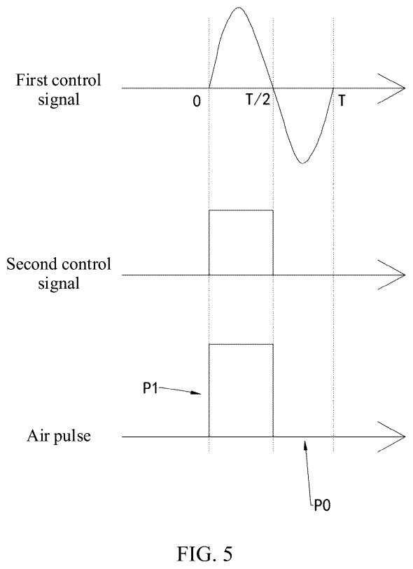

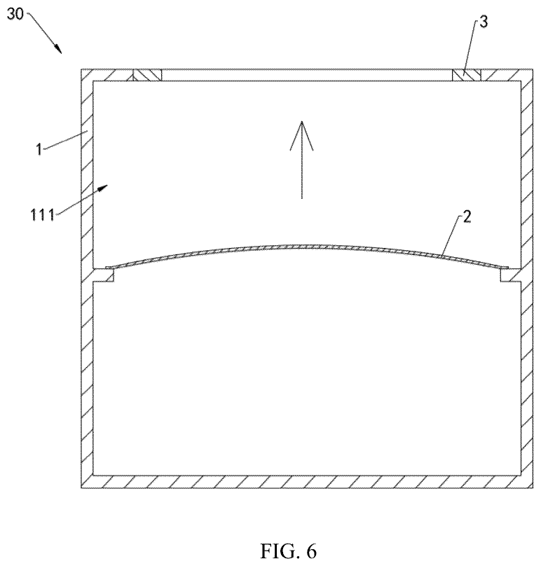

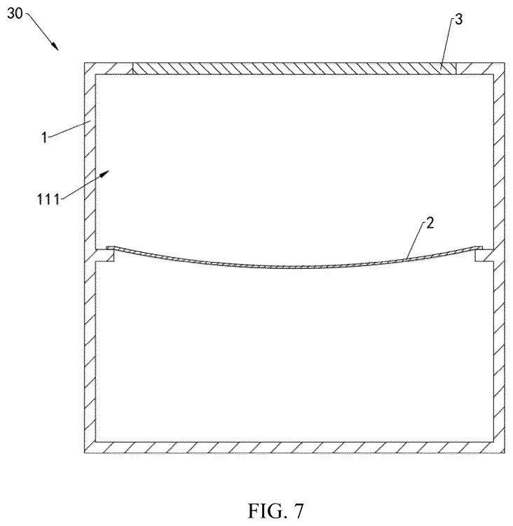

FIG. 5 is a diagram of the sound generating apparatus 100 shown in FIG. 1 in some usage statuses. FIG. 6 is a diagram of an internal structure of the air pulse generating assembly 30 shown in FIG. 4 in some usage statuses. FIG. 7 is a diagram of an internal structure of the air pulse generating assembly 30 shown in FIG. 4 in some other usage statuses. The usage statuses of the air pulse generating assembly 30 in FIG. 6 and FIG. 7 correspond to the usage statuses in FIG. 5.

For example, as shown in FIG. 5, a waveform of the first control signal may be a sine wave. A phase in a time period from 0 to T/2 is positive, and is used to drive the vibration member of the ultrasonic transducer 2 to move upward from the balance position and then return to the balance position. A phase in a time period from T/2 to T is negative, and is used to drive the vibration member of the ultrasonic transducer 2 to move downward from the balance position and then return to the balance position. A waveform of the second control signal may be a square wave. A level in a corresponding time period from 0 to T/2 is 1, and is used to control the first valve 3 to be switched on. A level in a corresponding time period from T/2 to T is 0, and is used to control the first valve 3 to be switched off.

As shown in FIG. 5 and FIG. 6, in the time period from 0 to T/2, the vibration member of the ultrasonic transducer 2 moves upward from the balance position and then returns to the balance position. The first valve 3 is switched on, the air in the front cavity 111 is pushed into the external space of the housing 1 by the vibration member, and the air pulse formed by the ultrasonic transducer 2 is the positive pulse P1. As shown in FIG. 5 and FIG. 7, in the time period from T/2 to T, the vibration member of the ultrasonic transducer 2 moves downward from the balance position and then returns to the balance position. The first valve 3 is switched off, and the air pulse formed by the ultrasonic transducer 2 is the null pulse P0.

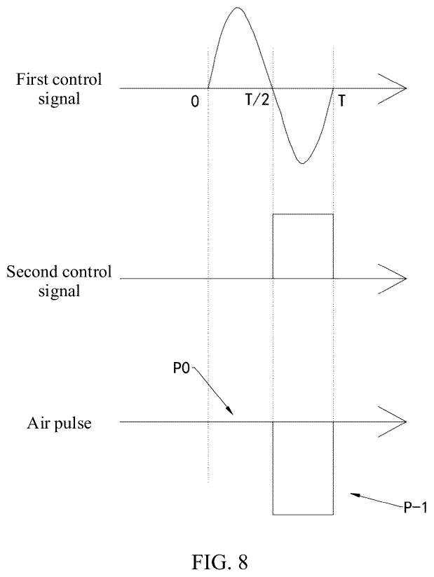

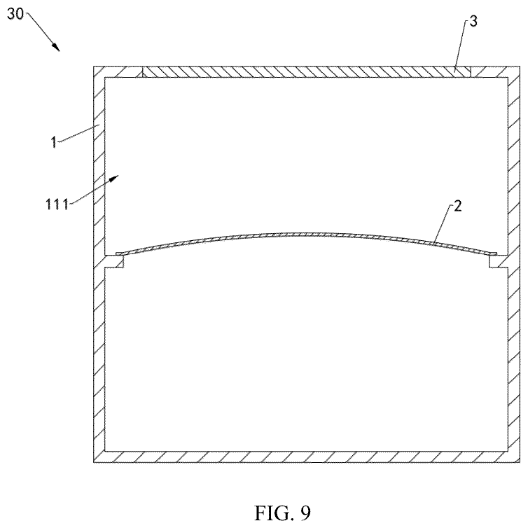

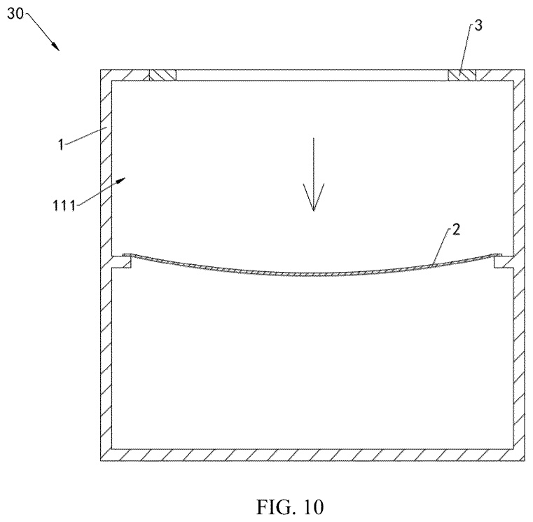

FIG. 8 is a diagram of the sound generating apparatus 100 shown in FIG. 1 in some other usage statuses. FIG. 9 is a diagram of an internal structure of the air pulse generating assembly 30 shown in FIG. 4 in some usage statuses. FIG. 10 is a diagram of an internal structure of the air pulse generating assembly 30 shown in FIG. 4 in some other usage statuses. The usage states of the air pulse generating assembly 30 in FIG. 9 and FIG. 10 correspond to the usage states in FIG. 8.

For example, as shown in FIG. 8, a waveform of the first control signal may be a sine wave. A phase in a time period from 0 to T/2 is positive, and is used to drive the vibration member of the ultrasonic transducer 2 to move upward from the balance position and then return to the balance position. A phase in a time period from T/2 to T is negative, and is used to drive the vibration member of the ultrasonic transducer 2 to move downward from the balance position and then return to the balance position. A waveform of the second control signal may be a square wave. A level in a corresponding time period from 0 to T/2 is 0, and is used to control the first valve 3 to be switched off. A level in a corresponding time period from T/2 to T is 1, and is used to control the first valve 3 to be switched on.

As shown in FIG. 8 and FIG. 9, in the time period from 0 to T/2, the vibration member of the ultrasonic transducer 2 moves upward from the balance position and then returns to the balance position. The first valve 3 is switched off, and the air pulse formed by the ultrasonic transducer 2 is the null pulse P0. As shown in FIG. 8 and FIG. 10, in the time period from T/2 to T, the vibration member of the ultrasonic transducer 2 moves downward from the balance position and then returns to the balance position. The first valve 3 is switched on, the air in the external space of the housing 1 enters the front cavity 111, and the air pulse formed by the ultrasonic transducer 2 is the negative pulse P-1.

### Second Implementation

In a process of reciprocating vibration of the vibration member of the ultrasonic transducer 2, in a time period in which the vibration member moves upward, the first valve 3 is switched on, air in the front cavity 111 is pushed into the external space of the housing 1, and the ultrasonic transducer 2 generates the positive pulse P1. In a time period in which the vibration member moves downward, the first valve 3 is switched on, air in the external space of the housing 1 is sucked into the front cavity 111, and the ultrasonic transducer 2 generates the negative pulse P-1. In the process of reciprocating vibration of the vibration member, the first valve 3 is switched off, and the ultrasonic transducer 2 generates the null pulse P0.

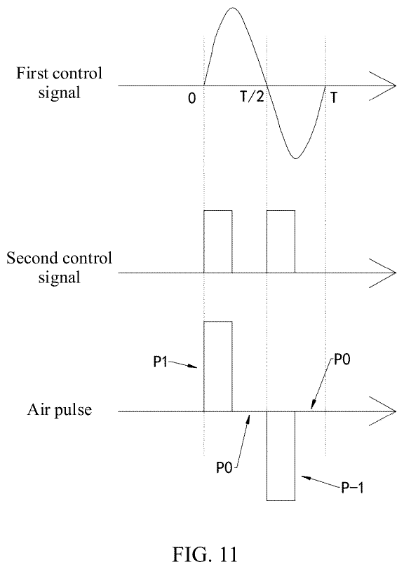

FIG. 11 is a diagram of the sound generating apparatus 100 shown in FIG. 1 in some other usage statuses.

For example, a waveform of the first control signal may be a sine wave. A phase in a time period from 0 to T/2 is positive, and is used to drive the vibration member of the ultrasonic transducer 2 to move upward from the balance position and then return to the balance position. A phase in a time period from T/2 to T is negative, and is used to drive the vibration member of the ultrasonic transducer 2 to move downward from the balance position and then return to the balance position. A waveform of the second control signal may be a square wave. In a corresponding time period from 0 to T/2 and in a corresponding time period in which the vibration member moves upward, a level is 1 and is used to control the first valve 3 to be switched on, and the ultrasonic transducer 2 forms the positive pulse P1. In the corresponding time period from 0 to T/2 and in a corresponding time period in which the vibration member moves downward, a level is 0 and is used to control the first valve 3 to be switched off, and the ultrasonic transducer 2 forms the null pulse P0. In a corresponding time period from T/2 to T and in a corresponding time period in which the vibration member moves downward, a level is 1 and is used to control the first valve 3 to be switched on, and the ultrasonic transducer 2 forms the negative pulse P-1. In the corresponding time period from T/2 to T and in a corresponding time period in which the vibration member moves upward, a level is 0 and is used to control the first valve 3 to be switched off, and the ultrasonic transducer 2 forms the null pulse P0.

It may be understood that, when the sound generating apparatus 100 generates the plurality of air pulses of the modulated ultrasonic wave, the first implementation or the second implementation may be separately used, or the first implementation and the second implementation may be used in combination. This is not strictly limited in embodiments of this application.

In the foregoing two implementations, an example in which the waveform of the first control signal is a sine wave is used, and an example in which the waveform of the air pulse and the waveform of the second control signal are square waves is used. It may be understood that the waveform of the first control signal may alternatively be a triangular wave, a square wave, or another waveform, and the waveform of the air pulse and the waveform of the second control signal may alternatively be a sine wave, a triangular wave, or another waveform. In the following related description, for ease of description, an example in which the waveform of the first control signal is a sine wave is still used, and an example in which the waveform of the air pulse and the waveform of the second control signal are square waves is still used.

In this application, the sound generating apparatus 100 may form a modulated ultrasonic wave by using a plurality of modulation rules. A basic principle of the modulation rule is that an audio signal is converted into a target air pulse signal according to a pulse density modulation algorithm, a control signal is formed based on the target air pulse signal, the control signal controls the air pulse generating assembly 30 to form a modulated ultrasonic wave including a plurality of air pulses, and the modulated ultrasonic wave forms audible sound, where the audible sound corresponds to the audio signal. The target air pulse signal carries related information of a target air pulse, and a sound wave formed after the target air pulse is converted through pulse density modulation corresponds to the audio signal. Because the vibration member of the air pulse generating assembly 30 performs reciprocating motion at an ultrasonic frequency, the plurality of air pulses of the modulated ultrasonic wave are difficult to completely correspond to the target air pulse, and a small amount of distortion may exist. Therefore, the plurality of air pulses of the modulated ultrasonic wave may be as close as possible to the target air pulse by using the modulation rule.

The following uses an example to describe a conversion process between the target air pulse and the modulated ultrasonic wave in the modulation rule.

### First Modulation Rule

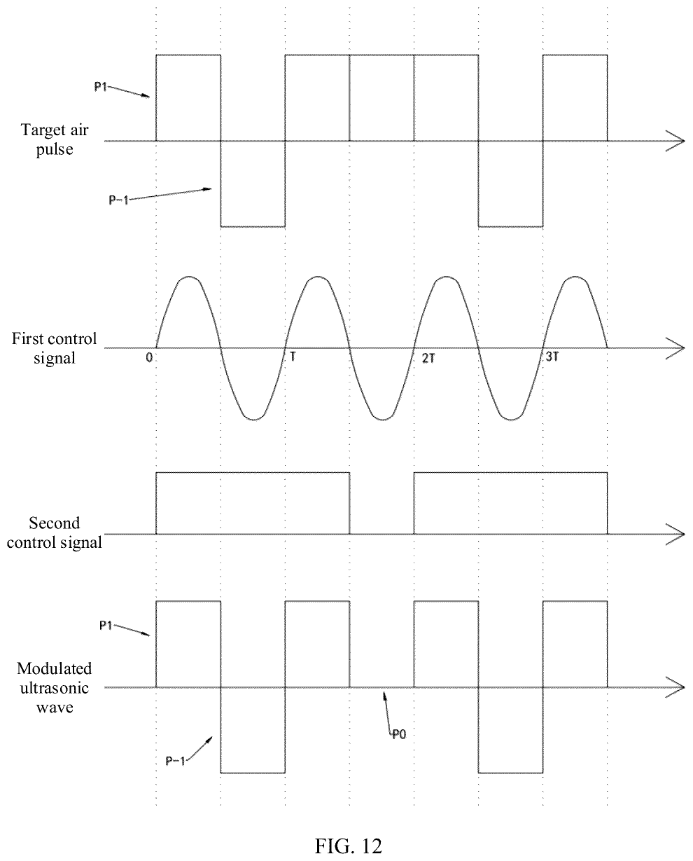

FIG. 12 is a diagram of a first modulation rule of the sound generating apparatus 100 shown in FIG. 1.

In the first modulation rule, a positive pulse P1, a negative pulse P-1, and a null pulse P0 of the modulated ultrasonic wave use the first implementation.

A frequency of the first control signal is one half of a pulse rate of the target air pulse. In this embodiment of this application, the pulse rate of the target air pulse is a maximum frequency at which a type can be selected for the target air pulse. When a type is selected for the target air pulse, a pulse type can be switched (for example, the positive pulse P1 is switched to the negative pulse P-1 or the null pulse P0), or the pulse type may remain unchanged. A first half cycle of a single cycle of the first control signal is defined as a positive half cycle, corresponding to a time period in which the vibration member of the air pulse generating assembly 30 moves upward from the balance position and then returns to the balance position. A second half cycle of the cycle of the first control signal is defined as a negative half cycle, corresponding to a time period in which the vibration member of the air pulse generating assembly 30 moves downward from the balance position and then returns to the balance position.

A frequency of the second control signal may be twice the frequency of the first control signal. In this embodiment of this application, the frequency of the second control signal is a maximum frequency at which content of the second control signal can be set or assigned. The frequency of the second control signal corresponds to a maximum frequency at which the first valve 3 can perform switch on/off state selection. The switch on/off state selection includes switching or maintaining a switch on state, and switching or maintaining a switch off state. When the second control signal is at a high level, the first valve 3 is controlled to be switched on. When the second control signal is at a low level, the first valve 3 is controlled to be switched off.

When the target air pulse is the positive pulse P1 and the first control signal is in the positive half cycle, the second control signal is set to a high level, to form the positive pulse P1 in a corresponding time period of the modulated ultrasonic wave. When the target air pulse is the negative pulse P-1 and the first control signal is in the negative half cycle, the second control signal is set to a high level, to form the negative pulse P-1 in a corresponding time period of the modulated ultrasonic wave. When the target air pulse is the null pulse P0, the second control signal is set to a low level, to form the null pulse P0 in a corresponding time period of the modulated ultrasonic wave. In this case, the target air pulse can be implemented in the corresponding time period of the modulated ultrasonic wave, so that the final audible sound can correspond to the audio signal.

In addition, when the target air pulse is the positive pulse P1 and the first control signal is the negative half cycle, or when the target air pulse is the negative pulse P-1 and the first control signal is in the positive half cycle, the second control signal is set to a low level, to form the null pulse P0 in a corresponding time period of the modulated ultrasonic wave. In this case, although the target air pulse is distorted in the corresponding time period of the modulated ultrasonic wave, a degree of distortion is relatively low, and a distortion proportion is relatively low. Therefore, a degree of distortion of the final audible sound relative to the audio signal can be reduced.

### Second Modulation Rule

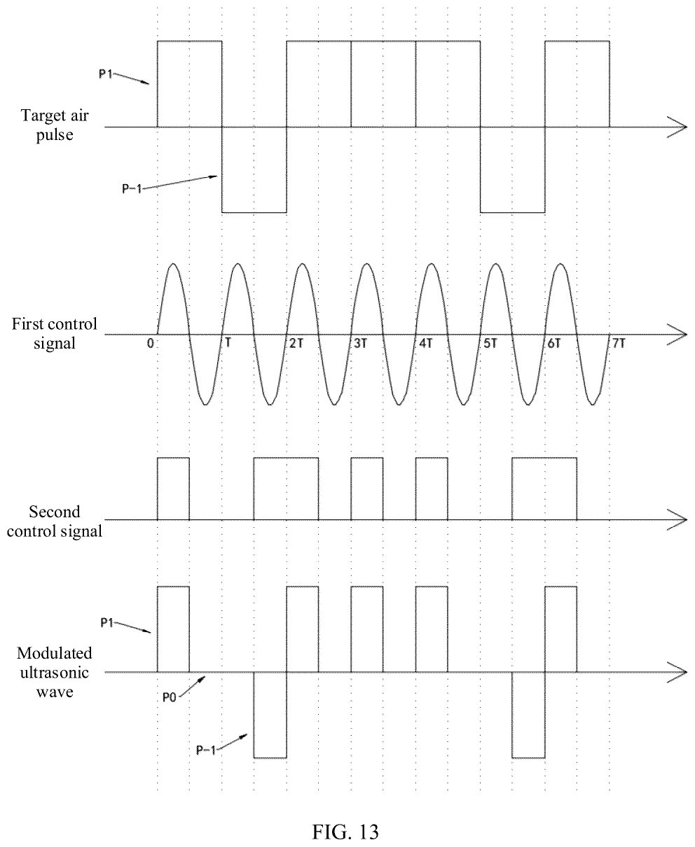

FIG. 13 is a diagram of a second modulation rule of the sound generating apparatus 100 shown in FIG. 1.

In the second modulation rule, a positive pulse P1, a negative pulse P-1, and a null pulse P0 of the modulated ultrasonic wave use the first implementation.

A frequency of the first control signal is the same as a pulse rate of the target air pulse. A first half cycle of a single cycle of the first control signal is defined as a positive half cycle, corresponding to a time period in which the vibration member of the air pulse generating assembly moves upward from the balance position and then returns to the balance position. A second half cycle of the cycle of the first control signal is defined as a negative half cycle, corresponding to a time period in which the vibration member of the air pulse generating assembly 30 moves downward from the balance position and then returns to the balance position.

A frequency of the second control signal may be twice the frequency of the first control signal. When the second control signal is at a high level, the first valve 3 is controlled to be switched on. When the second control signal is at a low level, the first valve 3 is controlled to be switched off.

When the target air pulse is the positive pulse P1 and the first control signal is in the positive half cycle, the second control signal is set to a high level, to form the positive pulse P1 in a corresponding time period of the modulated ultrasonic wave. When the target air pulse is the negative pulse P-1 and the first control signal is in the negative half cycle, the second control signal is set to a high level, to form the negative pulse P-1 in a corresponding time period of the modulated ultrasonic wave. In this case, the target air pulse can be implemented in the corresponding time period of the modulated ultrasonic wave, so that the final audible sound can correspond to the audio signal. In addition, because a single complete cycle of the first control signal corresponds to one target air pulse, and the frequency of the second control signal is twice the frequency of the first control signal, the first valve 3 may be accurately controlled to be switched on or switched off in the positive half cycle and the negative half cycle of the first control signal based on a type of the target air pulse, so that an air pulse matching the target air pulse is finally obtained by the modulated the ultrasonic wave, and a degree of distortion of the modulated ultrasonic wave is low.

In the first modulation rule and the second modulation rule, the frequency of the first control signal is easily limited by factors such as a material, a structure, and a size of the vibration member of the air pulse generating assembly 30. When the frequencies of the first control signals in the two modulation rules are the same, the pulse rate of the target air pulse in the first modulation rule is twice the pulse rate of the target air pulse in the second modulation rule. In this case, according to the first modulation rule, although a small amount of distortion exists in the modulated ultrasonic wave, high-quality conversion of the audio signal can still be implemented by using the target air pulse with a high pulse rate, so that sound quality and a sound pressure level of the audible sound are relatively high. According to the second modulation rule, although the pulse rate of the target air pulse is relatively low, because distortion of the modulated ultrasonic wave is small, high-quality conversion of the audio signal can also be implemented, so that sound quality and a sound pressure level of the audible sound are relatively high.

### Third Modulation Rule

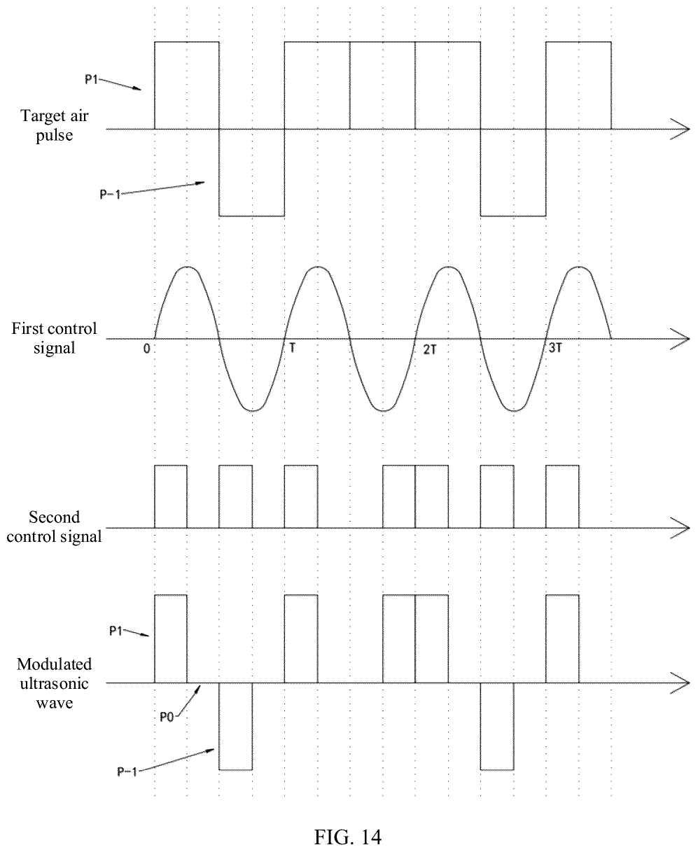

FIG. 14 is a diagram of a third modulation rule of the sound generating apparatus 100 shown in FIG. 1.

In the third modulation rule, a positive pulse P1, a negative pulse P-1, and a null pulse P0 of the modulated ultrasonic wave use the second implementation.

A frequency of the first control signal is one half of a pulse rate of the target air pulse. A first half cycle of a single cycle of the first control signal is defined as a positive half cycle, corresponding to a time period in which the vibration member of the air pulse generating assembly moves upward from the balance position and then returns to the balance position. A second half cycle of the cycle of the first control signal is defined as a negative half cycle, corresponding to a time period in which the vibration member of the air pulse generating assembly 30 moves downward from the balance position and then returns to the balance position. That is, the vibration member moves upward in a rising stage of the single cycle of the first control signal, and moves downward in a falling stage of the single cycle of the first control signal.

A frequency of the second control signal may be four times the frequency of the first control signal. When the second control signal is at a high level, the first valve 3 is controlled to be switched on. When the second control signal is at a low level, the first valve 3 is controlled to be switched off.

When the target air pulse is the positive pulse P1, and the first control signal is in the rising stage, the second control signal is set to a high level, to form the positive pulse P1 in a corresponding time period of the modulated ultrasonic wave. When the target air pulse is the negative pulse P-1, and the first control signal is in the falling stage, the second control signal is set to a high level, to form the negative pulse P-1 in a corresponding time period of the modulated ultrasonic wave. In addition, when the target air pulse is the positive pulse P1, and the first control signal is in the falling stage, the second control signal is set to a low level, to form the null pulse P0 in a corresponding time period of the modulated ultrasonic wave. When the target air pulse is the negative pulse P-1, and the first control signal is in a rising stage of a negative half cycle, the second control signal is set to a low level, to form the null pulse P0 in a corresponding time period of the modulated ultrasonic wave.

In the third modulation rule, because a half cycle of the first control signal corresponds to one target air pulse, and the frequency of the second control signal is four times the frequency of the first control signal, the first valve 3 may be accurately controlled to be switched on or switched off in the rising stage or the falling stage of the first control signal based on a type of the target air pulse, so that an air pulse matching the target air pulse is finally obtained by the modulated ultrasonic wave, the audible sound formed by the modulated ultrasonic wave can correspond to the audio signal, and a degree of distortion of the audible sound is low.

### Fourth Modulation Rule

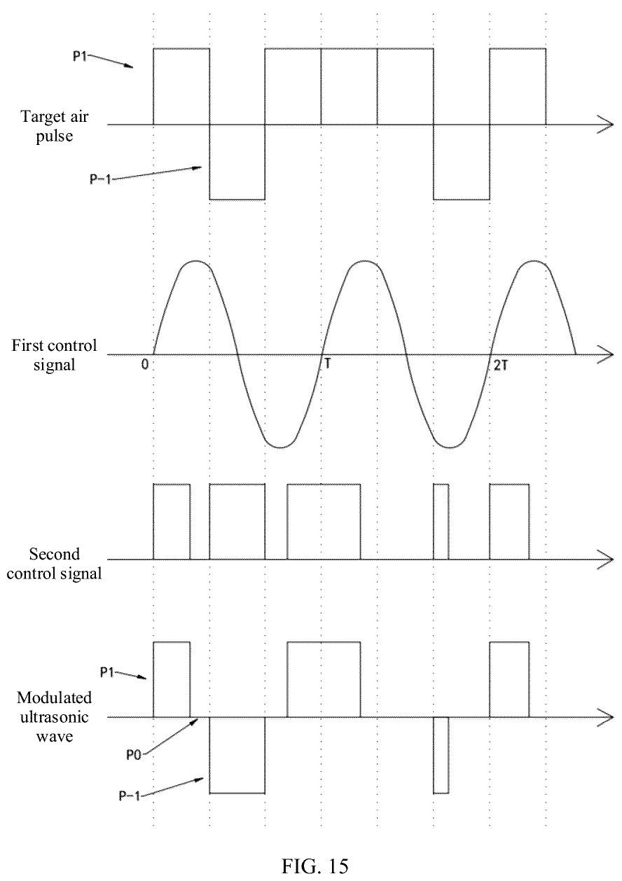

FIG. 15 is a diagram of a fourth modulation rule of the sound generating apparatus 100 shown in FIG. 1.

In the fourth modulation rule, a positive pulse P1, a negative pulse P-1, and a null pulse P0 of the modulated ultrasonic wave use the second implementation.

A frequency of the first control signal is less than one half of a pulse rate of the target air pulse. For example, the frequency of the first control signal is one third of the pulse rate of the target air pulse. A single cycle of the first control signal includes a rising stage and a falling stage, where the rising stage corresponds to a stage in which the vibration member of the air pulse generating assembly 30 moves upward, and the falling stage corresponds to a stage in which the vibration member of the air pulse generating assembly 30 moves downward.

A frequency of the second control signal is clearly greater than the frequency of the first control signal, and may be flexibly set based on the target air pulse and the first control signal, to reduce a degree of distortion of the modulated ultrasonic wave relative to the target air pulse as much as possible. For example, when the second control signal is at a high level, the first valve 3 is controlled to be switched on. When the second control signal is at a low level, the first valve 3 is controlled to be switched off. When the target air pulse is the positive pulse P1, and the first control signal is in the rising stage, the second control signal is set to a high level, to form the positive pulse P1 in a corresponding time period of the modulated ultrasonic wave. When the target air pulse is the negative pulse P-1, and the first control signal is in the falling stage, the second control signal is set to a high level, to form the negative pulse P-1 in a corresponding time period of the modulated ultrasonic wave. In addition, when the target air pulse is the positive pulse P1, and the first control signal is in the falling stage, the second control signal is set to a low level, to form the null pulse P0 in a corresponding time period of the modulated ultrasonic wave. When the target air pulse is the negative pulse P-1, and the first control signal is in a rising stage of a negative half cycle, the second control signal is set to a low level, to form the null pulse P0 in a corresponding time period of the modulated ultrasonic wave.

The first modulation rule to the fourth modulation rule are some of the modulation rules of the sound generating apparatus 100. The sound generating apparatus 100 may further have another modulation rule. This is not strictly limited in embodiments of this application.

In the modulation rule of the sound generating apparatus 100, the frequency of the second control signal may be greater than or equal to twice the frequency of the first control signal, so that the first valve 3 can implement selection of a switch on/off state for at least two times during one reciprocating vibration of the vibration member of the air pulse sound generating assembly, the sound generating apparatus 100 can smoothly emit a positive pulse P1, and/or a negative pulse P-1, and/or a null pulse P0, and the modulated ultrasonic wave can implement frequency adjustment and amplitude adjustment of the audible sound by adjusting the air pulse density.

It may be understood that, when the frequency of the second control signal is lower than twice the frequency of the first control signal, a selection frequency of the switch on/off state of the first valve 3 is too low, and switch on duration or switch off duration of the first valve 3 exceeds a half vibration cycle of the vibration member of the air pulse sound generating assembly, which easily causes unexpected energy cancellation of the positive pulse P1 and the negative pulse P-1 generated by the modulated ultrasonic wave, and causes problems such as energy waste and sound pressure level reduction.

In the modulation rule of the sound generating apparatus 100, the pulse rate of the plurality of air pulses of the modulated ultrasonic wave is the same as the frequency of the second control signal, and the pulse rate of the plurality of air pulses of the modulated ultrasonic wave is the maximum frequency at which a type can be selected for an air pulse. When the type is selected for the air pulse, a pulse type can be switched (for example, the positive pulse P1 is switched to the negative pulse P-1 or the null pulse P0), or the pulse type may remain unchanged, for example, in the first modulation rule to the fourth modulation rule.

For example, in the modulation rule of the sound generating apparatus 100, the frequency of the second control signal may be equal to twice the frequency of the first control signal, a maximum density of the positive pulse P1 of the modulated ultrasonic wave is the same as the frequency of the first control signal, and a maximum density of the negative pulse P-1 of the modulated ultrasonic wave is the same as the frequency of the first control signal, for example, in the first modulation rule and the second modulation rule.

In the foregoing modulation rules, an amplitude of the first control signal remains unchanged, and the amplitude for driving the vibration member of the ultrasonic transducer 2 remains unchanged, so that an initial ultrasonic wave with an unchanged amplitude is generated. In this case, the initial ultrasonic wave is a single-frequency ultrasonic wave, an operating frequency band of the vibration member of the ultrasonic transducer 2 is a narrow frequency band, and the vibration member only needs to have a relatively high response at a single point. Therefore, the ultrasonic transducer 2 can better use the resonant frequency of the vibration member to implement a response. This improves energy conversion efficiency and helps improve the sound pressure level.

In some other embodiments, the amplitude of the first control signal may also change, and a change of the amplitude of the first control signal causes the sound pressure level of the air pulse to change. In this case, the sound generating apparatus 100 can adjust the sound pressure level of the audible sound by adjusting the air pulse density of the second sound wave and the sound pressure level of the air pulse, and an adjustment range of the sound pressure level of the audible sound is wider. For example, when the air pulse density of the second sound wave is increased, the sound pressure level of at least a part of the air pulse is increased at the same time, to further improve the sound pressure level of the audible sound.

Based on the foregoing sound generating manner and modulation rules, the sound generating apparatus 100 may have a plurality of implementation structures, which are described in the following by using examples.

Refer to FIG. 4 again. In some embodiments, the inner cavity 11 of the housing 1 of the air pulse generating assembly 30 is divided into the front cavity 111 and the back cavity 112 by the ultrasonic transducer 2. For example, the sound generating apparatus 100 may divide the inner cavity 11 of the housing 1 independently by using the ultrasonic transducer 2, to form the front cavity 111 and the back cavity 112. In some other embodiments, the sound generating apparatus 100 may also cooperate with another structure (for example, a partial structure of the housing 1) by using the ultrasonic transducer 2, to jointly divide the inner cavity 11 of the housing 1, to form the front cavity 111 and the back cavity 112. This is not strictly limited in embodiments of this application.

The air pulse generating assembly 30 has a communicating hole 16, and the front cavity 111 and the back cavity 112 communicate through the communicating hole 16, to implement air pressure balance between the front cavity 111 and the back cavity 112, so that the ultrasonic transducer 2 can vibrate smoothly, to form an initial ultrasonic wave with a small degree of distortion under driving of the first control signal. For example, the communicating hole 16 may be disposed on the ultrasonic transducer 2.

A minimum width of the communicating hole 16 is greater than a thickness d_{μ} of a viscous layer, and the thickness of the viscous layer is

$${d}_{μ} = 0.22 mm ⋆ \sqrt{\frac{100 Hz}{f}} ,$$

where f is the frequency of the first control signal. The minimum width of the communicating hole 16 is a size of a narrowest position of a single communicating hole 16.

In this embodiment, a size of the communicating hole 16 is set, so that acoustic communication between the front cavity 111 and the back cavity 112 is implemented through the communicating hole 16. In this way, air in the front cavity 111 and air in the back cavity 112 can smoothly flow with each other through the communicating hole 16 in a process of reciprocating vibration of the ultrasonic transducer 2, to better implement air pressure balance between the front cavity 111 and the back cavity 112.

There may be a plurality of shapes of the communicating hole 16, provided that acoustic communication can be implemented. The shapes may include but are not limited to a round hole, a square hole, a long-strip hole, a slit, and the like. This is not strictly limited in embodiments of this application. There may be one or more communicating holes 16. This is not strictly limited in embodiments of this application. The acoustic communication means that sound can pass through the communicating hole.

For example, a back ventilation port 17 is disposed on the housing 1, and the back cavity 112 of the housing 1 and the external space of the housing 1 communicate through the back ventilation port 17, to implement air pressure balance between the back cavity 112 and the external space of the housing 1. There may be a plurality of shapes of the back ventilation port 17, provided that the back ventilation port 17 can be ventilated. The shapes may include but are not limited to a round hole, a square hole, a long strip hole, a slit, and the like. This is not strictly limited in embodiments of this application. There may be one or more back ventilation ports 17. This is not strictly limited in embodiments of this application.

The sound generating apparatus 100 may further be provided with a first acoustic mesh 18, and the first acoustic mesh 18 may be fastened to the housing 1 in a manner of bonding or the like, and cover the back ventilation port 17. The first acoustic mesh 18 is ventilated, so that the air pulse generating assembly 30 can still implement air pressure balance between the back cavity 112 and the external space of the housing 1 through the back ventilation port 17. In addition, the first acoustic mesh 18 can implement acoustic isolation between the back cavity 112 and the external space of the housing 1, so that a sound wave in the back cavity 112 does not leak into the external space of the housing 1. Ventilation means that media on two sides of an interface can be exchanged, and acoustic isolation means that sound cannot penetrate. A quantity, shapes, or the like of first acoustic meshes 18 are adapted to the back ventilation port 17. In some other embodiments, the sound generating apparatus 100 may not be provided with the first acoustic mesh 18. This is not strictly limited in embodiments of this application.

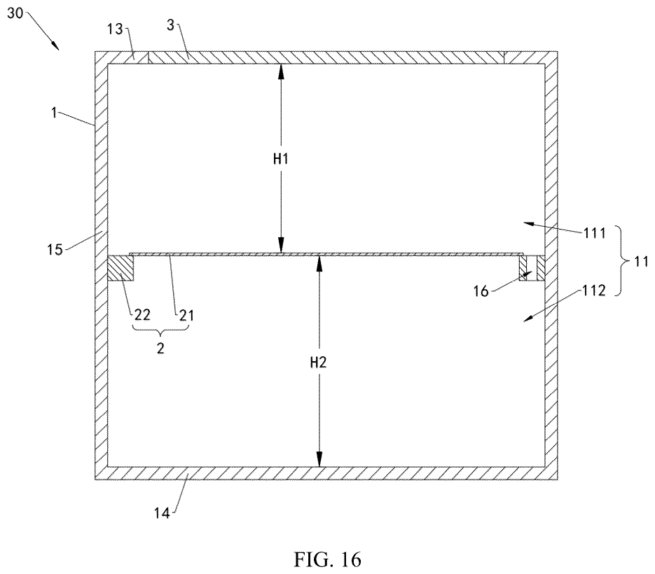

FIG. 16 is a diagram of an internal structure of the air pulse generating assembly 30 shown in FIG. 4.

In some embodiments, the ultrasonic transducer 2 includes a vibration member 21 and a support 22, and the vibration member 21 is fastened to the support 22. The vibration member 21 is configured to perform reciprocating motion under driving of the first control signal, to form an initial ultrasonic wave. The support 22 is fixedly connected to the housing 1, so that the ultrasonic transducer 2 is installed in the inner cavity 11 of the housing 1. The front cavity 111 is located on a side that is of the vibration member 21 and that faces the first valve 3, and the back cavity 112 is located on a side that is of the vibration member 21 and that is back to the front cavity 111.

For example, the support 22 may be fixedly connected to the side wall 15 of the housing 1. The first valve 3 may be fixedly connected to the top wall 13 of the housing 1, the front cavity 111 is located between the first valve 3 and the top wall 13 and the vibration member 21, and the back cavity 112 is located between the vibration member 21 and the bottom wall 14.

For example, the communicating hole 16 may be disposed on the support 22. In some other embodiments, the communicating hole 16 may alternatively be formed in a space between the vibration member 21 and the support 22. Certainly, the communicating hole 16 may alternatively have another implementation structure. This is not strictly limited in embodiments of this application.

In the air pulse generating assembly 30, when the initial ultrasonic wave is transmitted in the front cavity 111, problems such as the modulated ultrasonic wave finally emitted by the air pulse generating assembly 30 is prone to distortion and large energy loss due to phenomena such as sound wave reflection and sound wave cancellation in reverse phases.

For example, a distance H1 between the first valve 3 and the vibration member 21 is less than λ/2 in a vertical direction of the vibration member 21, and A is a wavelength of the initial ultrasonic wave. In this embodiment, the distance between the first valve 3 and the vibration member 21 affects a phase delay of the initial ultrasonic wave. By setting the distance between the first valve 3 and the vibration member 21 to be less than λ/2, a loss of the initial ultrasonic wave during transmission in the front cavity 111 can be reduced, to improve problems that the initial ultrasonic wave is prone to generate distortion, energy loss is large, and the like, improve energy conversion efficiency of the air pulse generating assembly 30, and help improve the sound pressure level of the audible sound.

In the air pulse generating assembly 30, when the vibration member 21 performs reciprocating vibration, the vibration member 21 also generates another ultrasonic wave in the back cavity 112. The ultrasonic wave is propagated and reflected in the back cavity 112. A part of the ultrasonic wave is transmitted to the front cavity 111 through the communicating hole 16, and is superposed with the initial ultrasonic wave. This part of the ultrasonic wave is referred to as a back cavity reflection sound wave in the following.

For example, a height H2 of the back cavity 112 is in a range of M*λ+λ/4−λ/8 to M*λ+λ/4+λ/8 in the vertical direction of the vibration member 21, λ is the wavelength of the initial ultrasonic wave, and M is a natural number. The height H2 of the back cavity 112 may be a distance between the vibration member 21 and the bottom wall 14 of the housing 1. In this embodiment, a phase of the back cavity reflection sound wave is the same as or close to a phase of the initial ultrasonic wave, and superposition of the back cavity reflection sound wave and the initial ultrasonic wave generates an enhancement effect, to help improve the sound pressure level of the audible sound.

For example, the height H2 of the back cavity 112 may be in a range of M*λ+λ/4−λ/9 to M*λ+λ/4+λ/9, or in a range of M*λ+λ/4−λ/10 to M*λ+λ/4+λ/10, to obtain a better sound wave superposition effect and a higher sound pressure level of the audible sound.

For example, the height H2 of the back cavity 112 is outside a range of M*λ+λ/2−λ/8 to M*λ+λ/2+λ/8 in the vertical direction of the vibration member 21, to avoid a cancellation problem caused by the superposition of the back cavity reflection sound wave and the initial ultrasonic wave, and reduce distortion of the modulated ultrasonic wave.

For example, the height H2 of the back cavity 112 is as far as possible outside a range of M*λ+λ/2−λ/9 to M*λ+λ/2+λ/9, or outside a range of M*λ+λ/2−λ/10 to M*λ+λ/2+λ/10.

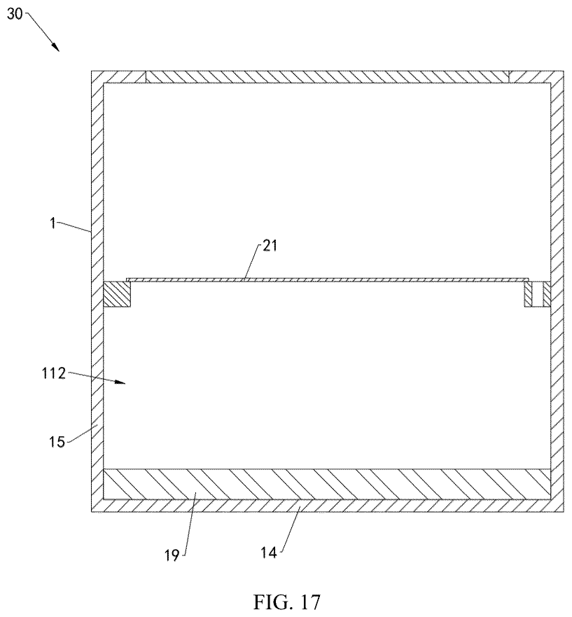

FIG. 17 is a diagram of an internal structure of the air pulse generating assembly 30 shown in FIG. 1 in some other embodiments. The air pulse generating assembly 30 in this embodiment may include most of technical features of the air pulse generating assembly 30 in the foregoing embodiments. The following mainly describes a difference between the two, and content that is the same between the two is not described again.

In some embodiments, the air pulse generating assembly 30 of the sound generating apparatus 100 is further provided with a sound-absorbing member 19, and the sound-absorbing member 19 is installed in the back cavity 112. The sound-absorbing member 19 may be sound-absorbing cotton, a local resonance sound-absorbing structure, another sound-absorbing structure, or the like. By deposing the sound-absorbing member 19, an ultrasonic wave emitted by the vibration member 21 to the back cavity 112 may be weakened or eliminated, to weaken or eliminate the back cavity reflection sound wave, reduce impact of the back cavity reflection sound wave on the modulated ultrasonic wave, and improve a sound pressure level of the audible sound. Through simulation calculation, the sound pressure level of the audible sound is improved by more than 3 dB and the distortion is reduced after the sound-absorbing member 19 is added to the air pulse generating assembly 30.

There are a plurality of installation solutions for the sound-absorbing member 19 in the back cavity 112. For example, the sound-absorbing member 19 may be of a plate structure or a laminated structure. In some examples, the sound-absorbing member 19 may be fastened to the bottom wall 14 of the housing 1, and the sound-absorbing member 19 covers a part or all of an area of the bottom wall 14. In some other examples, the sound-absorbing member 19 may further be fastened to an area that is in the side wall 15 of the housing 1 and that faces the back cavity 112, to increase a sound-absorbing area of the sound-absorbing member 19. In some other embodiments, the sound-absorbing member 19 may also be a relatively three-dimensional mechanical part, and may be fastened in the back cavity 112. It may be understood that a spacing is formed between the sound-absorbing member 19 and the vibration member 21, and space corresponding to the spacing serves as vibration space of the vibration member 21, to avoid interference caused by the sound-absorbing member 19 to vibration of the vibration member 21.

In some embodiments, because the sound-absorbing member 19 is disposed on the back cavity 112 of the air pulse generating assembly 30, the height of the back cavity 112 is designed more flexibly, and the height of the back cavity 112 may be the same as or different from that in the foregoing embodiment (for example, the embodiment corresponding to FIG. 16).

It may be understood that, in the embodiment corresponding to FIG. 16, when the height of the back cavity 112 of the air pulse generating assembly 30 is less than λ/4, λ is the wavelength of the initial ultrasonic wave, and the back cavity reflection sound wave easily enters the front cavity 111, causing interference to a phase of the initial ultrasonic wave in the front cavity 111 and serious distortion of the modulated ultrasonic wave. In the embodiment corresponding to FIG. 17, for example, the height of the back cavity 112 is less than λ/4 in the vertical direction of the vibration member 21. In this case, the sound-absorbing member 19 is disposed on the back cavity 112 of the air pulse generating assembly 30, to weaken or eliminate the back cavity reflection sound wave to reduce distortion of the modulated ultrasonic wave, and make the height of the back cavity 112 less than λ/4 to reduce an overall height of the air pulse generating assembly 30, which helps miniaturization of the air pulse generating assembly 30 and the sound generating apparatus 100.

For example, the height of the back cavity 112 may be less than or equal to 1 mm, the sound-absorbing member is disposed in the back cavity 112, and the height of the back cavity 112 may be, for example, 0.95 mm, 0.8 mm, or 0.87 mm, so that overall heights of the air pulse generating assembly 30 and the sound generating apparatus 100 are small, the volume is small, and distortion of the modulated ultrasonic wave is small. A frequency of the first control signal may be about 40 kHz.

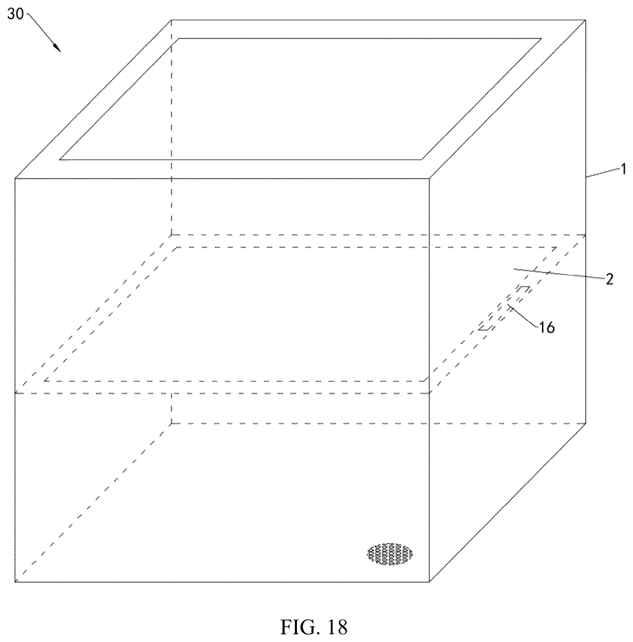

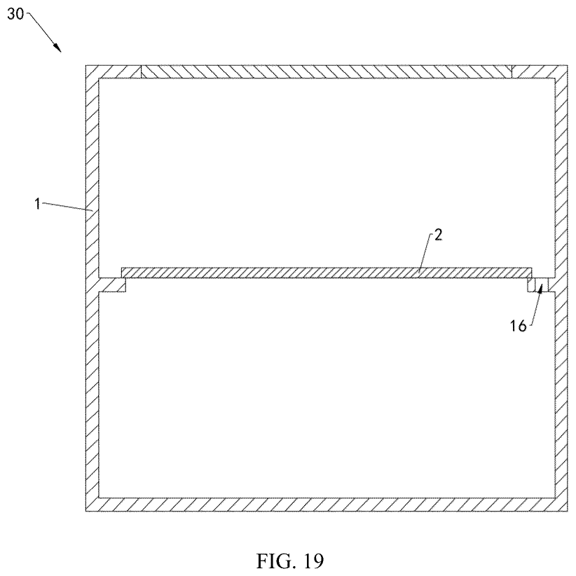

FIG. 18 is a diagram of an internal structure of the air pulse generating assembly 30 shown in FIG. 1 in some other embodiments. FIG. 19 is a diagram of an internal structure of the air pulse generating assembly 30 shown in FIG. 18.

The air pulse generating assembly 30 in this embodiment may include most of technical features of the air pulse generating assembly 30 in the foregoing embodiments. A main difference between the two lies in that in this embodiment, the communicating hole 16 of the air pulse generating assembly 30 is disposed on the housing 1. When the communicating hole 16 is disposed on the housing 1, processing difficulty of the communicating hole 16 is relatively low, and processing difficulty and costs of the ultrasonic transducer 2 can be reduced. For another design of the air pulse generating assembly 30 in this embodiment, refer to the related descriptions in the foregoing embodiments. Details are not described herein again.

It may be understood that in some other embodiments, when there are a plurality of communicating holes 16 of the air pulse generating assembly 30, some of the communicating holes 16 may be formed on the ultrasonic transducer 2, and some of the communicating holes 16 may be formed on the housing 1.

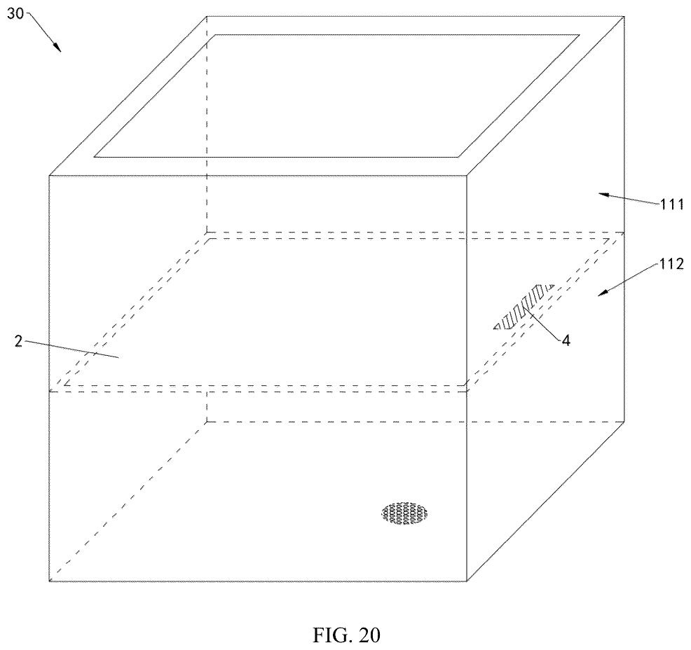

FIG. 20 is a diagram of an internal structure of the air pulse generating assembly 30 shown in FIG. 1 in some other embodiments. The air pulse generating assembly 30 in this embodiment may include most of technical features of the air pulse generating assembly 30 in the foregoing embodiments. The following mainly describes a difference between the two, and content that is the same between the two is not described again.

In some embodiments, the air pulse generating assembly 30 further includes a second valve 4, and the second valve 4 may be disposed on the ultrasonic transducer 2. When the second valve 4 is switched on, the front cavity 111 communicates with the back cavity 112, to balance a pressure of the front cavity 111 and a pressure of the back cavity 112. When the second valve 4 is switched off, the front cavity 111 and the back cavity 112 are separated. A difference between this embodiment and the foregoing embodiment lies in that the communicating hole 16 is replaced with the second valve 4 that may be selectively switched on, to more flexibly adjust a communication state of the front cavity 111 and the back cavity 112.

The second valve 4 may use a piezoelectric structure. For example, the second valve 4 includes a piezoelectric sheet, where one end of the piezoelectric sheet is a fixed end relative to the housing 1, and the other end is a movable end relative to the housing 1. When the piezoelectric sheet is powered off, the piezoelectric sheet separates the front cavity 111 from the back cavity 112 to implement switch off. When the piezoelectric sheet is powered on, the piezoelectric sheet deforms, and the movable end of the piezoelectric sheet is tilted, pressed, shifted, or the like, so that the front cavity 111 and the back cavity 112 communicate, to implement switch on. Certainly, the second valve 4 may further have another piezoelectric structure, or the second valve 4 may also use another non-piezoelectric structure. This is not strictly limited in embodiments of this application.

For example, the control circuit 20 (refer to FIG. 1) of the sound generating apparatus 100 is further electrically connected to the second valve 4, and the control circuit 20 is further configured to generate a third control signal, where the third control signal is used to control a switch on/off state of the second valve 4.

In a process of reciprocating vibration of the vibration member of the air pulse generating assembly 30 of the ultrasonic transducer 2, the second valve 4 may be switched on according to any rule, to implement pressure balance between the front cavity 111 and the back cavity 112. A switch on/off moment, switch on/off duration, and a switch on/off state switching frequency of the second valve 4 are set flexibly, and the third control signal is less limited by the first control signal and the second control signal.

In addition, a switch on frequency of the second valve 4 should not be too low, to ensure that pressure states of the front cavity 111 and the back cavity 112 of the air pulse generating assembly 30 can meet a basic requirement of smooth vibration of the vibration member, and reduce a degree of vibration distortion of the vibration member. For example, the third control signal is used to control a switch on cycle of the second valve 4 to be less than or equal to 20 times a cycle of the first control signal. That is, in a time period in which the vibration member of the ultrasonic transducer 2 vibrates for 20 cycles, the second valve 4 is switched on at least once, so that the front cavity 111 and the back cavity 112 communicate, and the pressure of the front cavity 111 and the pressure of the back cavity 112 are balanced.

A minimum width of an acoustic flow channel when the second valve 4 is switched on is greater than a thickness d_{μ} of a viscous layer, and the thickness of the viscous layer is

$${d}_{μ} = 0.22 mm ⋆ \sqrt{\frac{100 Hz}{f}} ,$$

where f indicates the frequency of the first control signal. The minimum width of the acoustic flow channel is a size of a narrowest position of the acoustic flow channel. In this embodiment, when the second valve 4 is switched on, acoustic communication between the front cavity 111 and the back cavity 112 is formed.

When the second valve 4 is always in a switch on state, the second valve 4 may also be considered as a communicating hole.

For example, in a structure implementation solution of the air pulse generating assembly 30, communicating space such as a through hole, a slit, or a gap may be disposed on the ultrasonic transducer 2, and the second valve 4 covers the communicating space, so that the front cavity 111 and the back cavity 112 communicate when the second valve 4 is switched on, and the front cavity 111 is separated from the back cavity 112 when the second valve 4 is switched off. A structure implementation solution is not strictly limited in embodiments of this application.

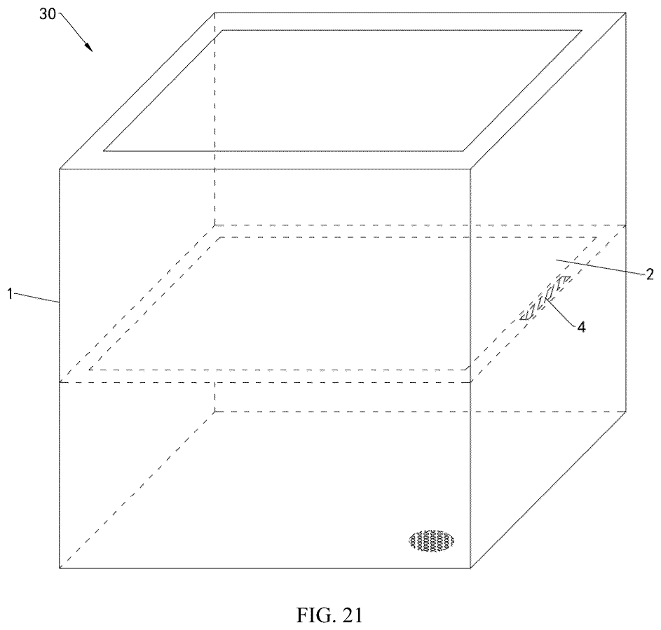

FIG. 21 is a diagram of an internal structure of the air pulse generating assembly 30 shown in FIG. 1 in some other embodiments.

The air pulse generating assembly 30 in this embodiment may include most of technical features of the air pulse generating assembly 30 in the foregoing embodiment (for example, the embodiment corresponding to FIG. 20). A main difference between the two lies in that in this embodiment, the second valve 4 of the air pulse generating assembly 30 is disposed on the housing 1. When the second valve 4 is disposed on the housing 1, processing difficulty and costs of the ultrasonic transducer 2 can be reduced. For another design of the air pulse generating assembly 30 in this embodiment, refer to the related descriptions in the foregoing embodiments. Details are not described herein again.

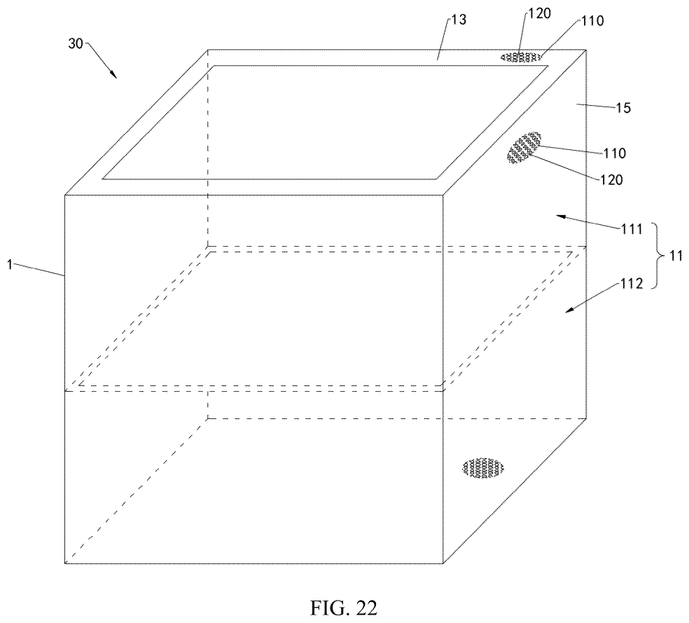

FIG. 22 is a diagram of an internal structure of the air pulse generating assembly 30 shown in FIG. 1 in some other embodiments. The air pulse generating assembly 30 in this embodiment may include most of technical features of the air pulse generating assembly 30 in the foregoing embodiments. The following mainly describes a difference between the two, and content that is the same between the two is not described again.

In some embodiments, the inner cavity 11 of the housing 1 of the air pulse generating assembly 30 is divided into the front cavity 111 and the back cavity 112 by the ultrasonic transducer 2, and the front cavity 111 and the back cavity 112 do not communicate with each other. That is, in an operating process of the air pulse generating assembly 30, the front cavity 111 and the back cavity 112 are always separated and do not communicate. For example, the housing 1 is provided with a front ventilation port 110, and the front cavity 111 of the housing 1 and the external space of the housing 1 communicate through the front ventilation port 110. In this embodiment, by disposing the front ventilation port 110, pressure balance between the front cavity 111 of the housing 1 and the external space of the housing 1 is maintained, so that the vibration member 21 of the ultrasonic transducer 2 can vibrate smoothly, to form a sound wave.

The front ventilation port 110 may be disposed on the top wall 13 and/or the side wall of the housing 1. This is not strictly limited in embodiments of this application. There may be a plurality of shapes of the front ventilation port 110, provided that the front ventilation port 110 can be ventilated. The shapes may include but are not limited to a round hole, a square hole, a long strip hole, a slit, and the like. This is not strictly limited in embodiments of this application. There may be one or more front ventilation ports 110. This is not strictly limited in embodiments of this application.

The sound generating apparatus 100 may further be provided with a second acoustic mesh 120. The second acoustic mesh 120 may be fastened to the housing 1 in a manner of bonding or the like, and cover the front ventilation port 110. The second acoustic mesh 120 is ventilated, so that the air pulse generating assembly 30 can still implement air pressure balance between the front cavity 111 and the external space of the housing 1 through the front ventilation port 110. In addition, the second acoustic mesh 120 can implement acoustic isolation between the front cavity 111 and the external space of the housing 1, so that a sound wave in the front cavity 111 does not leak into the external space of the housing 1. A quantity, shapes, or the like of second acoustic meshes 120 are adapted to the front ventilation port 110. In some other embodiments, the sound generating apparatus 100 may not be provided with the second acoustic mesh 120. This is not strictly limited in embodiments of this application.

The sound generating apparatus 100 in this application may be configured to generate audible sound of a medium and low frequency (20 Hz to 2000 Hz), or may be configured to generate audible sound of a full frequency band (20 Hz to 20000 Hz). The sound generating apparatus 100 may be used independently, or a plurality of sound generating apparatuses 100 may also be used in combination, or the sound generating apparatus 100 may be used in combination with other speakers of the same type or different types such as a piezoelectric speaker and a moving-coil speaker. For example, the sound generating apparatus 100 in this application implements medium and low frequency audible sound, and a speaker like the piezoelectric speaker or the moving-coil speaker implements high frequency audible sound.

In this application, the frequency of the audible sound depends on the air pulse density of the modulated ultrasonic wave, and the air pulse density is implemented based on the initial ultrasonic wave. The ultrasonic transducer 2 performs reciprocating vibration under driving of the first control signal to generate the initial ultrasonic wave. Therefore, the frequency of the audible sound is closely related to the frequency of the first control signal.

In some embodiments, the frequency of the first control signal is less than 400 kHz, so that the modulated ultrasonic wave forms audible sound with a frequency in a range of 20 Hz to 2 kHz. In some other embodiments, the frequency of the first control signal is greater than or equal to 400 kHz, so that the modulated ultrasonic wave forms audible sound with a frequency in a range of 20 Hz to 20 kHz. In the foregoing embodiments, the frequency design of the first control signal can make the degree of distortion of the modulated ultrasonic wave relatively low and the sound pressure level of the audible sound relatively high.

In order to cover audible sound of a full frequency band, the conventional speaker requires the vibration member not to have an excessively obvious resonance state in the frequency band of the audible sound, in other words, does not have excessively high sound in a frequency/narrow frequency band range, to affect hearing, and also requires the vibration member to have a strong response in a wide frequency band. This has a very high requirement on the vibration member of the speaker, and is usually difficult to implement. In addition, due to this requirement, the conventional speaker cannot use the resonance state, and energy utilization is low, which results in a relatively low sound pressure level of the generated sound.

In some embodiments of this application, because the ultrasonic transducer 2 is configured to perform reciprocating vibration to generate the initial ultrasonic wave, and the initial ultrasonic wave is a single-frequency ultrasonic wave, the resonant frequency of the vibration member of the ultrasonic transducer 2 is set to be the same as or close to the frequency of the expected initial ultrasonic wave, that is, the same as or close to the frequency of the first control signal. This can improve a response degree of the vibration member of the ultrasonic transducer 2 to the first control signal, and energy utilization is high, which helps improve the sound pressure level of the audible sound.

For example, the frequency of the first control signal is the same as the resonant frequency of the vibration member of the ultrasonic transducer 2, so that a matching degree between the initial ultrasonic wave and the first control signal is high, thereby helping improve a sound pressure level that can be improved.

For example, when the vibration member of the ultrasonic transducer 2 is of a piezoelectric structure, a high Q value feature of the piezoelectric structure may be used for driving, to improve energy conversion efficiency, so that energy utilization of the ultrasonic transducer 2 is high. A Q value is called a quality factor, and a high Q value means a low sound wave energy loss (an attenuation rate is directly proportional to a square of a frequency).

The ultrasonic transducer 2 may have a plurality of basic implementation structures. The following uses an example for description. A structure of the ultrasonic transducer 2 in the following can be used in any air pulse generating assembly 30 described above.

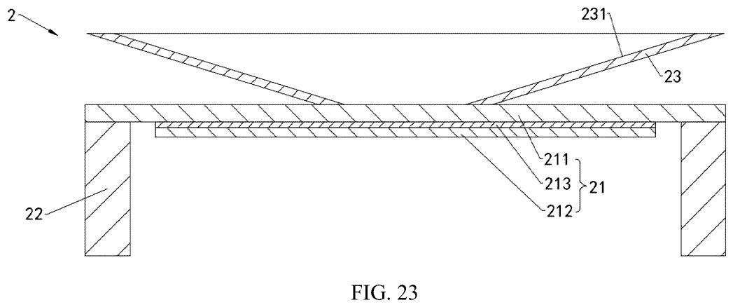

FIG. 23 is a diagram of a structure of an ultrasonic transducer 2 according to an embodiment of this application in some embodiments;

In some embodiments, the ultrasonic transducer 2 may be a piezoelectric ultrasonic transducer. The ultrasonic transducer 2 includes a support 22 and a vibration member 21. The vibration member 21 includes a vibrating membrane 211 and a piezoelectric sheet 212. A peripheral edge of the vibrating membrane 211 is fastened to the support 22, and the piezoelectric sheet 212 is fastened to a middle part of the vibrating membrane 211. For example, the piezoelectric sheet 212 includes a piezoelectric material layer, and in this case, the ultrasonic transducer 2 is a piezoelectric single crystal ultrasonic transducer. The piezoelectric material layer may be made of a piezoelectric material like lead zirconate titanate piezoelectric ceramics (lead zirconate titanate piezoelectric ceramics, PZT for short). The piezoelectric sheet 212 may be bonded to the vibrating membrane 211 by using an adhesive layer 213. The piezoelectric sheet 212 may be located on an upper surface or a lower surface of the vibrating membrane 211. This is not strictly limited in embodiments of this application. The vibrating membrane 211 may be made of a material like aluminum. In this embodiment, because of a high Q value feature of the piezoelectric sheet 212, the ultrasonic transducer 2 has relatively high energy conversion efficiency.

By adjusting a material and a geometric size of the ultrasonic transducer 2, a resonant frequency of the vibration member 21 of the ultrasonic transducer 2 can be adjusted, so that the resonant frequency falls within an expected frequency range. For example, the resonant frequency of the vibration member 21 is designed to be 40 kHz, to be applicable to a sound generating apparatus 100 that needs to form audible sound of a medium and low frequency. An example in which the piezoelectric sheet 212 is of a circular sheet structure is used for description. A piezoelectric material is PZT-5H, a polarization direction is a thickness direction of the piezoelectric sheet 212, and a voltage is applied to an upper surface and a lower surface of the piezoelectric sheet 212. A radius of the piezoelectric sheet 212 is 4 mm, and a thickness of the piezoelectric sheet 212 is 0.8 mm. A material of the vibrating membrane 211 is aluminum, and a thickness of the vibrating membrane 211 is 0.2 mm. In this case, the resonant frequency of the vibration member 21 is 40 kHz or close to 40 kHz.

The ultrasonic transducer 2 in this embodiment is mainly configured to emit an initial ultrasonic wave with a frequency less than 400 kHz. By reducing an area of the piezoelectric sheet 212, and/or increasing a thickness of the piezoelectric sheet 212, and/or increasing the thickness of the vibrating membrane 211 material, and/or increasing hardness of the vibrating membrane 211 material, the resonant frequency of the vibration member 21 may be increased, so that the resonant frequency matches the expected frequency of the initial ultrasonic wave. A solution may be designed based on an actual requirement, and details are not described herein again. Certainly, in some designs, the ultrasonic transducer 2 in this embodiment may also be configured to emit an initial ultrasonic wave with a frequency greater than 400 kHz.

As shown in FIG. 23, in some embodiments, the ultrasonic transducer 2 may further include a sound wave pointing member 23, where the sound wave pointing member 23 is located above the vibration member 21, and the sound wave pointing member 23 is configured to limit a radiation direction of the initial ultrasonic wave generated by the ultrasonic transducer 2, to improve radiation efficiency of the initial ultrasonic wave and help improve the sound pressure level of the audible sound. The sound wave pointing member 23 may include a tapered emission surface 231, and the tapered emission surface 231 can narrow directivity of the initial ultrasonic wave to about 60°, which clearly improves radiation efficiency of the initial ultrasonic wave.

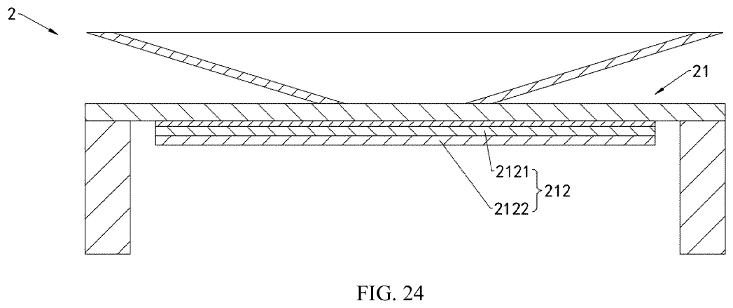

FIG. 24 is a diagram of a structure of an ultrasonic transducer 2 according to an embodiment of this application in some other embodiments. The ultrasonic transducer 2 in this embodiment may include most of technical features of the ultrasonic transducer 2 in the foregoing embodiments. The following mainly describes a difference between the two, and content that is the same between the two is not described again.

In some embodiments, a piezoelectric sheet 212 of a vibration member 21 of the ultrasonic transducer 2 may include a plurality of piezoelectric material layers that are stacked, and at least two piezoelectric material layers in the plurality of piezoelectric material layers have opposite polarization directions or opposite applied voltage directions. In this case, the ultrasonic transducer 2 is a piezoelectric double crystal ultrasonic transducer.

For example, the piezoelectric sheet 212 includes two piezoelectric material layers. For example, the piezoelectric sheet 212 includes a first piezoelectric material layer 2121 and a second piezoelectric material layer 2122. Polarization directions of the first piezoelectric material layer 2121 and the second piezoelectric material layer 2122 are opposite, or directions of applied voltages of the first piezoelectric material layer 2121 and the second piezoelectric material layer 2122 are opposite. It may be understood that, in some other embodiments, the piezoelectric sheet 212 may alternatively include three or more piezoelectric material layers.

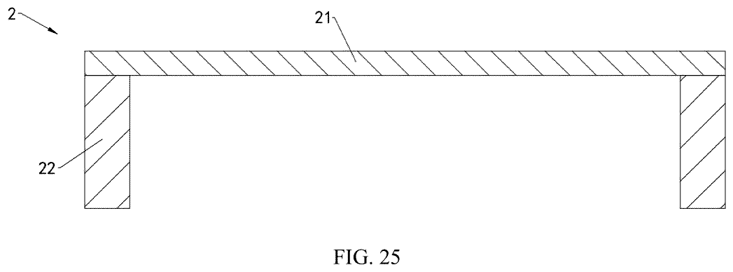

FIG. 25 is a diagram of a structure of an ultrasonic transducer 2 according to an embodiment of this application in some other embodiments. The ultrasonic transducer 2 in this embodiment may include most of technical features of the ultrasonic transducer 2 in the foregoing embodiments. The following mainly describes a difference between the two, and content that is the same between the two is not described again.

In some embodiments, the ultrasonic transducer 2 includes a support 22 and a vibration member 21. The vibration member 21 is a piezoelectric sheet, and the piezoelectric sheet is fastened to the support 22. The piezoelectric sheet may include one or more piezoelectric material layers, and the piezoelectric material layer may be made of a piezoelectric material like lead zirconate titanate piezoelectric ceramics. When the piezoelectric sheet includes a plurality of piezoelectric material layers, the plurality of piezoelectric material layers are stacked.

In this embodiment, the ultrasonic transducer 2 may use a relatively thick piezoelectric ceramic block as the piezoelectric sheet, and the piezoelectric sheet directly forms the vibration member 21 without using a vibrating membrane, to have a relatively high resonant frequency. For example, the resonant frequency of the vibration member 21 of the ultrasonic transducer 2 in this embodiment may be greater than or equal to 400 kHz, for example, the resonant frequency may be designed as 500 kHz, 600 kHz, or the like.

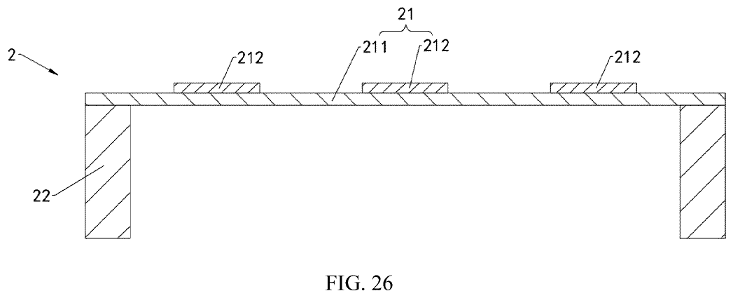

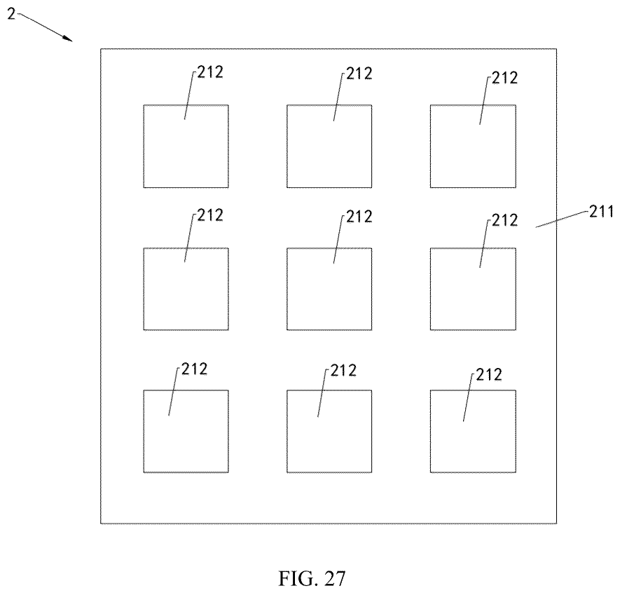

FIG. 26 is a diagram of a structure of an ultrasonic transducer 2 according to an embodiment of this application in some other embodiments. FIG. 27 is a diagram of a partial structure of the ultrasonic transducer 2 shown in FIG. 26. The ultrasonic transducer 2 in this embodiment may include most of technical features of the ultrasonic transducer 2 in the foregoing embodiments. The following mainly describes a difference between the two, and content that is the same between the two is not described again.

In some embodiments, the ultrasonic transducer 2 includes a support 22 and a vibration member 21, the vibration member 21 includes a vibrating membrane 211 and a plurality of piezoelectric sheets 212, a peripheral edge of the vibrating membrane 211 is fastened to the support 22, and the plurality of piezoelectric sheets 212 are fastened to a middle part of the vibrating membrane 211. The piezoelectric sheet 212 may include one or more piezoelectric material layers, and the piezoelectric sheet 212 may be a single crystal piezoelectric sheet or a double crystal piezoelectric sheet. Resonant frequencies of the plurality of piezoelectric sheets 212 are the same. The plurality of piezoelectric sheets 212 are arranged at spacings, for example, may be arranged in an array or another arrangement manner.

In this embodiment, the ultrasonic transducer 2 can be used in an application scenario of a large vibration area. In a solution in which only one piezoelectric sheet is disposed on the vibration member 21, because a resonant frequency of the piezoelectric sheet 212 decreases as an area of the piezoelectric sheet 212 increases, it is difficult to implement high-frequency ultrasonic radiation. In this embodiment, by disposing the plurality of piezoelectric sheets 212, each piezoelectric sheet 212 can have a relatively high resonant frequency, and the plurality of piezoelectric sheets 212 arranged on a plane on which the vibrating membrane 211 is located vibrate together, which also helps improve a sound pressure level of an initial ultrasonic wave, so that a sound pressure level of audible sound formed by the sound generating apparatus 100 is relatively high.

The resonant frequency of the vibration member 21 of the ultrasonic transducer 2 in this embodiment may be greater than or equal to 400 kHz, to help the sound generating apparatus 100 implement sound generating in all frequency bands. In some other embodiments, the resonant frequency of the vibration member 21 of the ultrasonic transducer 2 may alternatively be less than 400 kHz.

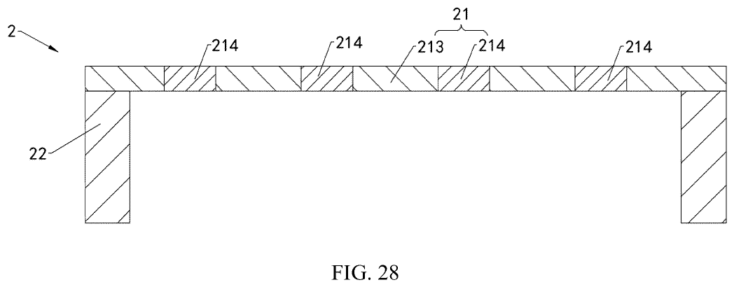

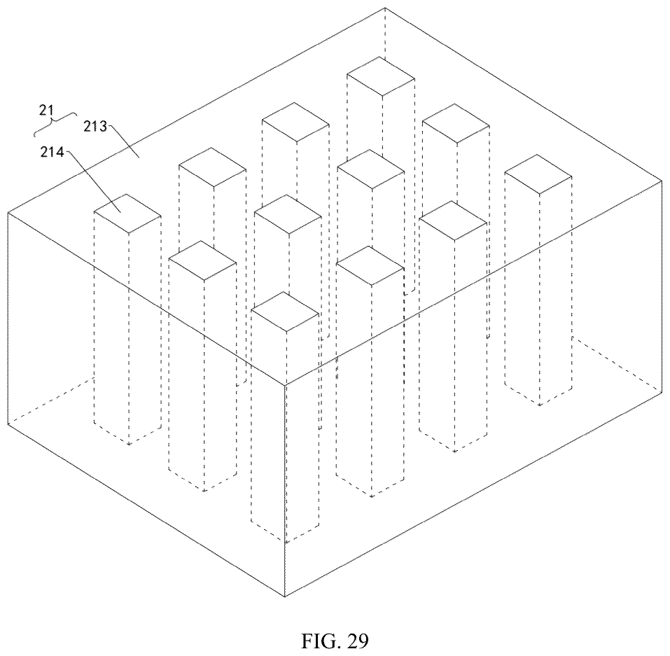

FIG. 28 is a diagram of a structure of an ultrasonic transducer 2 according to an embodiment of this application in some other embodiments. FIG. 29 is a diagram of a partial structure of the ultrasonic transducer 2 shown in FIG. 28. The ultrasonic transducer 2 in this embodiment may include most of technical features of the ultrasonic transducer 2 in the foregoing embodiments. The following mainly describes a difference between the two, and content that is the same between the two is not described again.

In some embodiments, the ultrasonic transducer 2 includes a support 22 and a vibration member 21, and the vibration member 21 is fastened to the support 22. The vibration member 21 includes a substrate 213 and a plurality of piezoelectric components 214. The substrate 213 may be made of a polymer material like epoxy resin. The piezoelectric component 214 may be made of a piezoelectric material like lead zirconate titanate piezoelectric ceramics. The plurality of piezoelectric components 214 are embedded in the substrate 213.

The substrate 213 may be approximately of a thin plate structure, the plurality of piezoelectric components 214 are arranged along a plate surface direction of the substrate 213, and the plate surface direction of the substrate 213 is vertical to a thickness direction of the substrate 213. The plurality of piezoelectric components 214 are arranged at spacings, that is, a spacing is formed between two adjacent piezoelectric components 214. For example, the plurality of piezoelectric components 214 may be arranged in an array or another arrangement manner. FIG. 29 shows a structure of a partial area of the vibration member 21, and only one of the piezoelectric components 214 is signed in FIG. 29.

In this embodiment, the vibration member 21 is of a piezoelectric composite structure. Compared with a pure piezoelectric ceramic structure, the piezoelectric composite structure has improved structure strength and reliability, and a resonant frequency of the vibration member 21 is relatively high. For example, the resonant frequency of the vibration member 21 in this embodiment may be greater than or equal to 400 kHz. Certainly, in some other embodiments, the resonant frequency of the vibration member 21 of the ultrasonic transducer 2 may alternatively be less than 400 kHz.

In addition, the piezoelectric composite structure of the vibration member 21 in this embodiment helps prepare a large-area piezoelectric component array. Resonant frequencies of the plurality of piezoelectric components 214 in the piezoelectric component array are the same. A relatively large number of piezoelectric components 214 are disposed on the vibration member 21, so that a sound pressure level of an initial ultrasonic wave generated by the vibration member 21 can be improved. This improves a sound pressure level of a modulated ultrasonic wave generated by the sound generating apparatus 100, so that a sound pressure level of audible sound is relatively high.

In some other embodiments, the ultrasonic transducer 2 may alternatively be a polyvinylidene fluoride (polyvinylidene difluoride, PVDF) piezoelectric film transducer. The vibration member of the ultrasonic transducer 2 is a polyvinylidene fluoride piezoelectric film. The polyvinylidene fluoride piezoelectric film may implement ultrasonic emission on a curved surface or a plane in a simple constraint manner, and a frequency is relatively high. A resonant frequency of the vibration member is usually in a range of 1 MHz to 100 MHz. In this case, the vibration member of the ultrasonic transducer 2 can easily obtain a resonant frequency of more than 400 kHz. Certainly, in some other embodiments, the resonant frequency of the vibration member 21 of the ultrasonic transducer 2 may alternatively be another resonant frequency, for example, less than 400 kHz.

In some other embodiments, the ultrasonic transducer 2 may alternatively be a micromachined ultrasonic transducer (Micromachined Ultrasonic Transducer, MUT). For example, the ultrasonic transducer 2 may be a capacitive micromachined ultrasonic transducer (capacitive micromachined ultrasonic transducer, cMUT) or a piezoelectric micromachined ultrasonic transducer (piezoelectric micromachined ultrasonic transducer, pMUT). In this embodiment, the resonant frequency of the vibration member of the ultrasonic transducer 2 is usually high, for example, may be greater than or equal to 400 kHz. Certainly, in some other embodiments, the resonant frequency of the vibration member 21 of the ultrasonic transducer 2 may alternatively be less than 400 kHz.

Both the capacitive micromachined ultrasonic transducer and the piezoelectric micromachined ultrasonic transducer are micro ultrasonic transducers manufactured by using an MEMS (Micro-Electro-Mechanical System, micro-electro-mechanical system) process. For the capacitive micromachined ultrasonic transducer, usually a cavity is formed on a silicon substrate, a top surface of the cavity is a vibrating membrane material like nitride, and a signal is applied by using an electrode material, so that ultrasonic emission is implemented. For the piezoelectric micromachined ultrasonic transducer, usually a piezoelectric material like lead zirconate titanate piezoelectric ceramics is superposed on a silicon substrate, and similarly, after a signal is applied by using electrodes, an ultrasonic wave is generated due to piezoelectric inverse effect. The two types of ultrasonic transducers 2 based on the MEMS process can conveniently implement an arrayed design, which helps improve a sound pressure level of an initial ultrasonic wave generated by a vibration member, to improve a sound pressure level of a modulated ultrasonic wave generated by the sound generating apparatus 100, so that a sound pressure level of audible sound is relatively high.

It may be understood that, in addition to the foregoing embodiments, the ultrasonic transducer 2 may alternatively have another implementation structure. This is not strictly limited in embodiments of this application.

The air pulse generating assembly 30 in the foregoing embodiments is described by using an example in which the air pulse generating assembly 30 includes one ultrasonic transducer 2. In some other embodiments, the air pulse generating assembly 30 may alternatively include a plurality of ultrasonic transducers 2. The following provides an example for description.

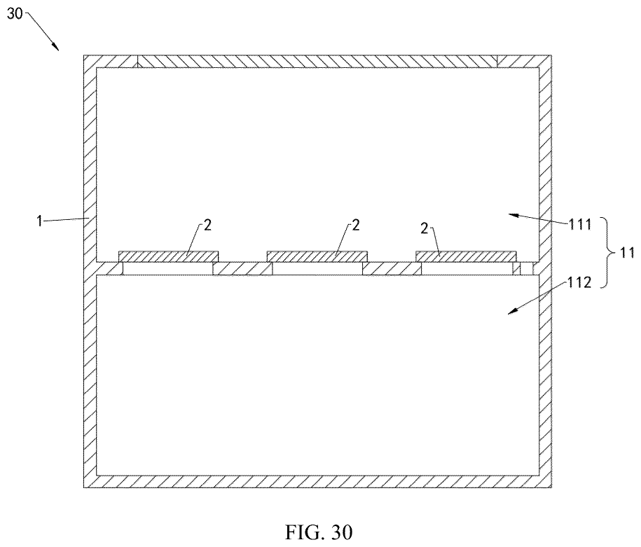

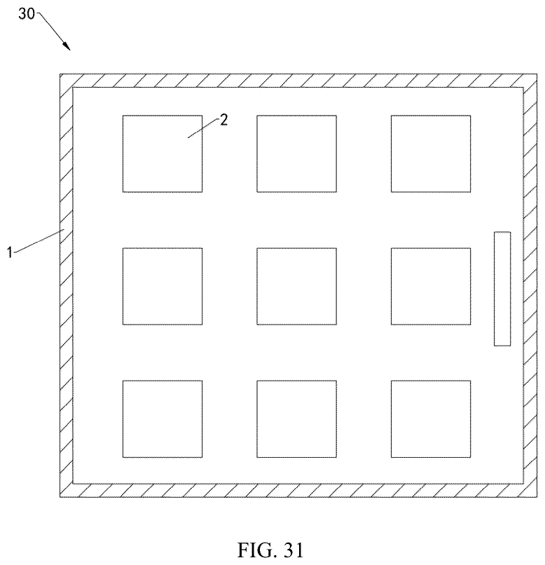

FIG. 30 is a diagram of a structure of the air pulse generating assembly 30 shown in FIG. 1 in some other embodiments. FIG. 31 is a diagram of a partial structure of the air pulse generating assembly 30 shown in FIG. 30. The ultrasonic transducer 2 in this embodiment may include most of technical features of the ultrasonic transducer 2 in the foregoing embodiments. The following mainly describes a difference between the two, and content that is the same between the two is not described again.

In some embodiments, the air pulse generating assembly 30 includes a plurality of ultrasonic transducers 2. The plurality of ultrasonic transducers 2 are all installed in the inner cavity 11 of the housing 1, and are all located between the front cavity 111 and the back cavity 112. Resonant frequencies of vibration members of the plurality of ultrasonic transducers 2 are the same. A structure of the ultrasonic transducer 2 may be any structure described above. The plurality of ultrasonic transducers 2 may be arranged in an array or another arrangement manner.

In this embodiment, the air pulse generating assembly 30 can be used in an application scenario of a large volume and large horizontal space. In this embodiment, the air pulse generating assembly 30 is provided with the plurality of ultrasonic transducers 2. The vibration member of each ultrasonic transducer 2 can have a relatively high resonant frequency, and a sound pressure level of an initial ultrasonic wave can be improved, so that a sound pressure level of audible sound generated by the sound generating apparatus 100 is relatively high.

For example, the resonant frequency of the vibration member of the ultrasonic transducer 2 in this embodiment may be greater than or equal to 400 kHz, to help the sound generating apparatus 100 implement sound generating in all frequency bands. In some other embodiments, the resonant frequency of the vibration member of the ultrasonic transducer 2 may alternatively be less than 400 kHz.

The foregoing embodiments are merely intended for describing a part of the technical solutions of this application, but not for limiting this application. Although this application is described in detail with reference to the foregoing embodiments, a person of ordinary skilled in the art should understand that: when no conflict occurs, modifications may still be made to the technical solutions described in the foregoing embodiments, or equivalent replacements may be made to some technical features, or combination may be made to the technical solutions recorded in different embodiments, and such modifications or replacements or combination do not cause the essence of the corresponding technical solutions to depart from the scope of the technical solutions of embodiments of this application.

1. A sound generating apparatus, comprising a housing, a transducer, a first valve, and a control circuit, wherein
the housing has an inner cavity and an opening, the inner cavity of the housing and external space of the housing communicate through the opening of the housing;
the transducer is installed in the inner cavity of the housing to divide the inner cavity of the housing into a front cavity and a back cavity, the front cavity is located between the back cavity and the opening;
the first valve is fastened to the housing and covers the opening of the housing;
the control circuit is electrically connected to the transducer and the first valve, the control circuit is configured to generate a first control signal and a second control signal, the first control signal is configured to drive a vibration member of the transducer to vibrate, the second control signal is configured to control a switch on/off state of the first valve such that the sound generating apparatus emits a plurality of air pulses to form audible sound having a frequency lower than a vibration frequency of the vibration member of the transducer, wherein the plurality of air pulses comprise a positive pulse and a negative pulse, and a sound pressure level of the audible sound varies with proportions of the positive pulse and the negative pulse, or a quantity of positive pulses or a quantity of negative pulses.

2. The sound generating apparatus according to claim 1, wherein in a first time period, a larger difference between the quantity of positive pulses and the quantity of negative pulses indicates a higher sound pressure level of the audible sound.

3. The sound generating apparatus according to claim 2, wherein the positive pulse and the negative pulse in the plurality of air pulses have a same sound pressure level.

4. The sound generating apparatus according to claim 1, wherein a frequency of the first control signal is greater than or equal to 20 kHz, and an amplitude of the first control signal remains unchanged.

5. The sound generating apparatus according to claim 4, wherein a frequency of the second control signal is greater than or equal to twice the frequency of the first control signal.

6. The sound generating apparatus according to claim 4, wherein a frequency of the second control signal is equal to twice the frequency of the first control signal, and a maximum density of the positive pulse is the same as the frequency of the first control signal.

7. The sound generating apparatus according to claim 1, wherein the sound generating apparatus further comprises a second valve disposed on the transducer or the housing, when the second valve is switched on, the front cavity communicates with the back cavity.

8. The sound generating apparatus according to claim 7, wherein the control circuit is electrically connected to the second valve, the control circuit is further configured to generate a third control signal, and the third control signal is used to control a switch on cycle of the second valve to be less than or equal to 20 times a cycle of the first control signal.

9. The sound generating apparatus according to claim 1, wherein the transducer or the housing is provided with a communicating hole, and the front cavity and the back cavity communicate through the communicating hole.

10. The sound generating apparatus according to claim 1, wherein the front cavity and the back cavity do not communicate with each other, the housing is provided with a front ventilation port, and the front cavity of the housing and the external space of the housing communicate through the front ventilation port.

11. The sound generating apparatus according to claim 1, wherein the housing is provided with a back ventilation port, and the back cavity of the housing and the external space of the housing communicate through the back ventilation port.

12. The sound generating apparatus according to claim 1, wherein the frequency of the first control signal is less than 400 kHz, so that the sound generating apparatus generates audible sound with a frequency in a range of 20 Hz to 2 kHz; or
the frequency of the first control signal is greater than or equal to 400 kHz, so that the sound generating apparatus generates audible sound with a frequency in a range of 20 Hz to 20 KHz.

13. The sound generating apparatus according to claim 1, wherein
the transducer comprises a support, a vibrating membrane, and a piezoelectric sheet, wherein a peripheral edge of the vibrating membrane is fastened to the support, the piezoelectric sheet is fastened to a middle part of the vibrating membrane, and a resonant frequency of a vibration member formed by the vibrating membrane and the piezoelectric sheet is less than 400 kHz;
the transducer comprises a support and a piezoelectric sheet, wherein the piezoelectric sheet is fastened to the support, and a resonant frequency of the piezoelectric sheet is greater than or equal to 400 kHz;
the transducer comprises a support, a vibrating membrane, and a plurality of piezoelectric sheets, wherein a peripheral edge of the vibrating membrane is fastened to the support, the plurality of piezoelectric sheets are fastened to a middle part of the vibrating membrane, resonant frequencies of the plurality of piezoelectric sheets are the same, and a resonant frequency of a vibration member formed by the vibrating membrane and the plurality of piezoelectric sheets is greater than or equal to 400 kHz;
the vibration member of the transducer comprises a substrate and a plurality of piezoelectric components, wherein the substrate is made of a polymer material, the plurality of piezoelectric components are embedded in the substrate, and a resonant frequency of the vibration member is greater than or equal to 400 kHz; or
the transducer is a polyvinylidene fluoride piezoelectric film transducer, a capacitive micromachined transducer, or a piezoelectric micromachined transducer, wherein a resonant frequency of the vibration member of the transducer is greater than or equal to 400 kHz.

14. The sound generating apparatus according to claim 1, wherein the sound generating apparatus comprises a plurality of transducers, the plurality of transducers are all installed in the inner cavity of the housing and located between the front cavity and the back cavity, and resonant frequencies of vibration members of the plurality of transducers are the same and are all greater than or equal to 400 kHz.

15. The sound generating apparatus according to claim 13, wherein the frequency of the first control signal is the same as the resonant frequency of the vibration member of the transducer.

16. The sound generating apparatus according to claim 1, wherein the vibration member of the transducer is configured to perform reciprocating motion under driving of the first control signal to generate a first sound wave.

17. The sound generating apparatus according to claim 16, wherein a distance between the first valve and the vibration member is less than λ/2 in a vertical direction of the vibration member, and λ is a wavelength of the first sound wave.

18. The sound generating apparatus according to claim 17, wherein a height of the back cavity is in a range of M*λ+λ/4−λ/8 to M*λ+λ/4+λ/8 in the vertical direction of the vibration member, λ is the wavelength of the first sound wave, and M is a natural number.

19. The sound generating apparatus according to claim 16, wherein the sound generating apparatus is further provided with a sound-absorbing member, and the sound-absorbing member is installed in the back cavity; and
a height of the back cavity is less than λ/4 in the vertical direction of the vibration member.

20. The sound generating apparatus according to claim 1, wherein the sound generating apparatus further comprises a signal processing circuit, the signal processing circuit is configured to convert an audio signal into a target air pulse signal according to a pulse density modulation algorithm, and the control circuit is configured to generate the first control signal and the second control signal based on the target air pulse signal.
